(19) United States
(12) Patent Application Publication
(10) Pub. No.: US 2014/0346099 A1
(43) Pub. Date: Nov. 27, 2014

(54) Methods, Systems, and Apparatus for Rainwater Harvesting and Cistern Storage Integrated with Irrigation

(71) Applicants: Thomas Paul Brantley, Tallahassee, FL (US); Joseph Colson Harvey, Tallahassee, FL (US)

(72) Inventors: Thomas Paul Brantley, Tallahassee, FL (US); Joseph Colson Harvey, Tallahassee, FL (US)

(73) Assignee: LEON COUNTY, FLORIDA, Tallahassee, FL (US)

(21) Appl. No.: 14/214,272

(22) Filed: Mar. 14, 2014

Related U.S. Application Data
(60) Provisional application No. 61/802,012, filed on Mar. 15, 2013.

(51) Int. Cl. A01G 25/00; E03B 11/04; B01D 21/26

(52) U.S. Cl. CPC A01G 25/00; B01D 21/267; E03B 11/04
USPC 210/127; 210/154; 210/136

(57) ABSTRACT

Rainwater run-off from a roof or other structure may be collected via a system of gutters and downspouts for delivery via gravity to a collection pipe, then via gravity to a connective pipe, and then via gravity to a filter system where the collected rainwater may be filtered and then delivered via gravity to one or more storage tanks When needed, the filtered rainwater may be pumped from the storage tank(s) via a distribution system to an irrigation system or other destination. The distribution system may include a hydropneumatic water tank and a centrifugal filter. If the storage tank(s) is/are empty, then an empty indicator may cause water from a water supply source to be used to irrigate instead of the filtered harvested rainwater.

### RELATED APPLICATION

This application claims priority to and the benefit of the prior filed co-pending and commonly owned provisional application entitled “Methods, Systems, and Apparatus for Rainwater Harvesting and Cistern Storage Integrated with Irrigation”, which was filed with the United States Patent and Trademark Office on Mar. 15, 2013, assigned U.S. Patent Application Ser. No. 61/802,012, and is incorporated herein by this reference.

### FIELD OF THE INVENTION

The inventions relate to harvesting of rainwater, water conservation, water filtering, water storage, and water irrigation.

### BACKGROUND

Water is precious. Water is especially precious when there is not enough of it such as in times of drought. To guard against water shortage, people have harvested water in various ways. One way has been to collect rainwater as it runs off the top of a building or other structure. The rainwater may be directed via gutters to downspouts, which deliver the water to storage devices.

A common storage device for rainwater harvested from a roof is a barrel located at ground level. The barrel usually receives the rainwater from the roof via one or more downspouts and stores the rainwater for use. There are several problems with rainwater barrel storage. First is size. A typical rain barrel has a capacity of about 55 gallons. To store more rainwater, a user has to have a bigger barrel. But a bigger barrel may have the same problem as the typical rain barrel. Harvested rainwater may exceed the bigger barrel's capacity. Another way to store more rainwater is to have more rain barrels. But more rain barrels mean more problems. For example, a system may be needed to fill the barrels with rainwater all at the same time, in sequence, and/or otherwise.

Another problem with rainwater barrel storage is filtration. Rainwater diverted off of a roof may contain undesirable particulates of various sizes. A typical rain barrel does not provide for filtration of the undesirable particulates.

Yet another problem with rainwater barrel storage is getting the water out of the barrel. A simple solution is to have a hose whose delivery end is lower in height than the accumulated water in the barrel. But this simple solution is not always feasible, especially when more than one rain barrel is used.

Most users who harvest rainwater in barrels in the United States generally do not rely entirely on what is stored in the barrels for water needs. The harvesting of rainwater, however, may become so prevalent that some users may come to rely on stored rainwater at least for irrigation needs. In the case of an extended dry spell, these users may need to switch to water from another source such as may be provided by a municipality or other government unit. The problem is that such a switch is not currently easily accommodated.

Accordingly, there is a need for devices, systems, and methods to harvest and store rainwater in such a manner as to accommodate various sized storage devices. There is a need for a varying range of filtration of the rainwater that is ultimately stored for future use. There is also a need for a way to move the filtered, stored rainwater to its use. Another need is a way to obtain other water resources when the filtered, stored rainwater is depleted.

### SUMMARY

Generally stated, the invention relates to systems, methods, and apparatus for harvesting rainwater by collecting, filtering, and storing it, and making the filtered rainwater available for irrigation or other purposes.

Advantageously, the embodiments of the invention allow for the utilization of harvested rainwater for landscape irrigation and/or other purposes. The harvested rainwater may substitute (in whole or in part) for other water sources such as utility treated water with the caveat that the harvested rainwater is filtered, but is not potable. The substitution of the harvested rainwater for the water from another source obviously leads to savings in water and sewer bills.

Other advantages, however, are not so obvious, but may be considered important. Utility treated potable water carries a high energy/carbon footprint. Reducing the use of utility treated water results in energy conservation and benefits the environment. Another environmental protection aspect of the embodiments of the invention is that reduction in the use of utility treated water by substitution of the harvested rainwater protects the finite aquifer that is the source for the utility treated water.

Moreover, the harvesting of rainwater may alleviate problems associated with storm water runoff. For example, storm water holding ponds are often necessary to prevent flooding. Such ponds may be eliminated or reduced in number and/or size if rainwater is harvested. This advantage applies to other drainage infrastructure that may otherwise be necessary if storm water runoff is not harvested. In addition, eliminating or reducing storm water runoff by harvesting may avoid or reduce the pollution of streams, rivers, and lakes by the particulates in the storm water runoff.

Three possible embodiments of the invention are now summarized. Other embodiments, of course, are possible.

The first embodiment is used in connection with a system for harvesting rainwater from a roof of a structure located above ground. The system includes one or more gutters positioned with respect to the roof to receive the rainwater. The gutters may include screens provided to prevent leaves, limbs, other deleterious matter, etc., from entering and potentially clogging or blocking the gutters against flow. The one or more gutters are further positioned to deliver by gravity the rainwater to one or more downspouts. Each downspout has a top end connected to the one or more gutters to receive the rainwater from the one or more gutters.

Together with the system described in the previous paragraph, the first embodiment is a system for filtering the rainwater, storing it, and using it to irrigate. The first embodiment includes a collection pipe located below the one or more downspouts. The collection pipe may include more than one pipe such as a series of progressively sized pipes. Each of the one or more downspouts has a bottom end opposite its top end with the bottom end of the downspout connected to the collection pipe so the collection pipe receives the rainwater via gravity from the one or more downspouts. The collection pipe has a downward slope at least at one end towards a connective pipe to which the collection pipe makes a watertight connection so the collection pipe delivers the rainwater via gravity to the connective pipe. The connective pipe also may be one or more pipes. The connective pipe has a downward slope from the collection pipe to a filter system to which the connective pipe makes a watertight connection so the connective pipe delivers the rainwater via gravity to the filter system.

In the first embodiment, the filter system is watertight and operational to filter debris from the rainwater runoff conveyed by the collection and connecting pipes such as debris that may still be present beyond pre-screening devices. The filter system may have watertight connections to piping. The piping delivers via watertight connection the filtered rainwater to a top opening in a storage tank, storage tanks, or bank or field of same.

Also in the first embodiment, the storage tank is watertight and has an outlet near or at its bottom. The outlet of the storage tank may be outfitted with a valve selectively operable by a controller to close the outlet to be watertight so as to store the filtered rainwater in the storage tank. The valve also may be selectively operable by the controller to open the outlet to release the filtered rainwater into a first end of an irrigation delivery piping system with which the outlet has a watertight connection.

Further, in the first embodiment, part of the connective pipe, part of the filter system, the whole storage tank, the pump, and at least part of the irrigation delivery piping system may be buried underground. If the storage tank is buried underground then hydrostatic flotation forces imposed by high ground waters may need to be taken into consideration. To negate these effects, the storage tank may be outfitted with a pressure relief valve, in lieu of structural anchors, to allow ground water to be filtered and to enter the tank until water levels and pressures are equalized. The storage tank includes a vent pipe. The vent pipe has a watertight connection at one end to an opening in the top of the underground storage tank providing access to the interior of the underground storage tank. The other end of the vent pipe is located above ground and has an opening to vent air from the interior of the underground storage tank to above ground.

Advantageously, the storage tank may be a tank at least previously intended for storing petroleum products. For example, the storage tank may be a cleaned, re-proofed and retrofitted single (or double) wall storage tank.

Continuing with the first embodiment, the controller may be communicatively connected to a valve or valves and to a pump or pumps on the outlet of the storage tank. The controller may be selectively operable to cause the valve(s) to open, to activate the pump(s), to cause the valve(s) to close, and to deactivate the pump(s).

Now referring to the irrigation delivery piping system of the first embodiment, the irrigation delivery piping system has a watertight connection at its second end to at least an irrigation system. The pump is operable with the irrigation delivery piping system when the pump is activated to pump the filtered rainwater through the irrigation delivery piping system from the outlet of the storage tank to the irrigation system.

In addition, the first embodiment may include a cut-off valve connected to the irrigation delivery piping system between the outlet of the storage tank and the pump. The cut-off valve may be selectively manually operable to block flow of the filtered rainwater in the irrigation delivery piping system before the filtered rainwater reaches the pump.

The first embodiment may include a hydropneumatic water tank connected to the irrigation delivery piping system. The hydropneumatic water tank may be operable to deliver the filtered rainwater in a preset pressure range to the irrigation system. Depending upon hydropneumatic tank (HT) and piping size and pressurization and capacity requirements, an auxiliary air compressor may be used to keep the air bladder in HT sufficiently charged.

Also, the first embodiment may include a centrifugal filter that acts as a hydrodynamic separator connected to the irrigation delivery piping system. The centrifugal filter may be used to filter particulates from the filtered rainwater prior to delivery of the filtered rainwater to the irrigation system.

The first embodiment may include additional in-line micro-filters, or polishing filters, as required for the further purification of the filtered rainwater for delivery to mist irrigation or drip irrigation devices used in the irrigation system.

Additionally, the first embodiment may include a piping connection. It is connected at one end to the irrigation system and connected at its other end to a water supply source. A water supply source (WSS) valve is connected between the piping connection and the water supply source. The WSS valve may be selectively operable to close the piping connection to be watertight so as to block water from the water supply source. The WSS valve also may be selectively operable to open the piping connection to allow the water from the water supply source to flow through the piping connection to the irrigation system. The controller may be communicatively connected to the WSS valve to selectively cause the WSS valve to open, or to cause the WSS valve to close. This first embodiment also may include a back flow preventer for preventing the filtered rainwater from entering the water supply source.

The first embodiment also may include a float switch disposed inside the storage tank and communicatively connected to the controller. The float switch may be operable to provide an indication to the controller when the storage tank is empty of the filtered rainwater. The controller may respond to the indication from the float switch that the storage tank is empty of the filtered rainwater. The controller may respond by causing the WSS valve to open to allow the water from the water supply source to flow through the piping connection to the irrigation system. There may be a check valve between the irrigation delivery piping system and the irrigation system for blocking the water from the water supply source.

A second embodiment of the invention is a system for filtering harvested rainwater, storing it, and delivering it to an irrigation system. This embodiment provides a ground excavation having a substantially flat bottom. The excavation is big enough to contain a storage tank. Bedding material is disposed on top of the bottom of the excavation. The storage tank is positioned in the excavation on the bedding material. Backfill is used to fill the excavation to bury the storage tank. The storage tank has at least a vent pipe that reaches above ground.

The second embodiment also includes a filter system for filtering debris from harvested rainwater delivered to the filter system. The filter system may be connected to the storage tank to deliver the filtered harvested rainwater to the storage tank or to divert excess flows than the available storage capacities of the storage tanks allow, safely to other surface water conveyance systems. The storage tank may be connected to a delivery system for delivering the filtered harvested rainwater to the irrigation system. The delivery system may be responsive to a signal to cause the storage tank to release the filtered harvested rainwater and to affect delivery of the filtered harvested rainwater to the irrigation system.

A third embodiment of the invention is a system for using stored rainwater for irrigation in an irrigation system. Advantageously, if there is no stored rainwater, the irrigation system of this third embodiment is connected to a water source for water to use for the irrigation.

The third embodiment provides a valve positioned between the water source and the irrigation system. The valve is closed to block the water from the water source from the irrigation system. The valve is responsive to an open signal from a controller to open to allow the use of the water from the water source for the irrigation by the irrigation system.

The third embodiment provides a storage system for storing the rainwater. The storage system may be an underground storage tank formerly used for storing gasoline and having an air vent to the surface. The storage system includes an empty indicator that sends an empty indication to the controller if the storage system is substantially empty of the stored rainwater. The empty indicator may be a float switch in the storage tank.

When the controller receives a turn-on irrigation instruction, in the third embodiment, the controller checks for an empty indication. If the controller fails to find the empty indication, the controller causes a distribution system to transport the stored rainwater from the storage system for delivery to the irrigation system. If the controller finds the empty indication, the controller sends the open signal to the valve to allow the use of the water from the water source for the irrigation by the irrigation system. In the third embodiment, the distribution system may include a filter. It may filter debris from the stored rainwater prior to the delivery of the rainwater to the irrigation system. The distribution system also may include a check valve between the irrigation system and the distribution system to prevent the water from the water supply from entering the distribution system. Further, the distribution system may include a pump and a hydropneumatic water tank.

Other features and advantages of the invention may be more clearly understood and appreciated from a review of the following detailed description and by reference to the appended drawings and claims.

### BRIEF DESCRIPTION OF THE DRAWINGS

FIG. 1 is an illustration of an overview of an exemplary embodiment of the invention.

FIG. 2a is a side view of an exemplary storage tank as may be used in an embodiment of the invention.

FIG. 2b is a perspective exploded view of the exemplary storage tank of FIG. 2a.

FIG. 3 is a side underground back view of elements of the exemplary embodiment of FIG. 1 and a block diagram representation of above ground elements of the exemplary embodiment of FIG. 1.

FIG. 4 is top view of a micro-contouring plan of a roof of a structure as may be used with an embodiment of the invention.

FIG. 5 is a top perspective view an exemplary filter system as may be used with an embodiment of the invention.

FIG. 6 is a front perspective view of an exemplary filter as may be used in the exemplary filter system shown in FIG. 5.

FIG. 7 is a side perspective view of an exemplary filter system as may be used with an embodiment of the invention.

FIG. 8 is a top view of the layout of an exemplary embodiment of the invention incorporating two pairs of storage tanks

FIG. 9 is a flow diagram providing an example of the logic that may be employed by a controller in operation of an exemplary embodiment of the invention.

### DETAILED DESCRIPTION

The invention is described herein at least in sufficient detail for a person skilled in the art to make or use the invention without undue experimentation. The invention is described by reference to exemplary embodiments including apparatuses, systems, and methods. The invention, however, should not be limited to the embodiments described herein, but may also cover other embodiments (not specifically described or shown herein) that may be implemented in accordance with the inventions.

Generally stated, embodiments of the invention may harvest rainwater by collecting and filtering it. The filtered rainwater may be stored (in whole or in part). The filtered rainwater may be transported from storage to a destination such as an irrigation system. If there is no filtered rainwater available from storage, then automatically in some embodiments, water from another water supply source may be provided to the irrigation system. A water supply source also may be referred to as a “water source”. Exemplary water supply sources include municipal water systems, commercial water systems, community owned water systems, interconnected cistern storage systems, etc.

For example, rainfall may be diverted from the roof of a structure through a system of gutters and downspouts to a piping system that may rely upon gravity to transport the rainwater to filtration and storage. The filtration may be progressive. The rainwater may be filtered via screens on the gutters and downspouts. A filter system may filter the rainwater. A hydrodynamic separator may filter especially small debris from the rainwater prior to its use as irrigation water. The degree of filtration may depend on the end use of the rainwater. For example, the rainwater destined for a fine sprinkler may need to be more filtered than rainwater destined for not so fine a sprinkler

Embodiments of the invention may use a pump or other mechanism to deliver the filtered rainfall from storage to a site where the filtered rainfall may be used for any of myriad of purposes including irrigation.

The description herein refers to the harvesting of “rainwater 12 that hits a roof” of a structure. The invention does not necessarily contemplate collection of 100% of the rainwater 12 that lands on a roof because some of the rainwater 12 may be lost to evaporation, or for other reasons. Further, embodiments of the invention may be constructed to collect less than all of the rainwater 12 that hits a roof For example, an embodiment of the invention may be implemented so that rainwater 12 hitting only one side of a roof is collected. Thus, the phrase “rainwater 12 that hits a roof” should be interpreted herein as applying to all or any portion of the rainwater 12 that falls upon a roof, unless otherwise noted.

Further, “rainwater 12” may also be referred to herein as “rain” or as “storm water”.

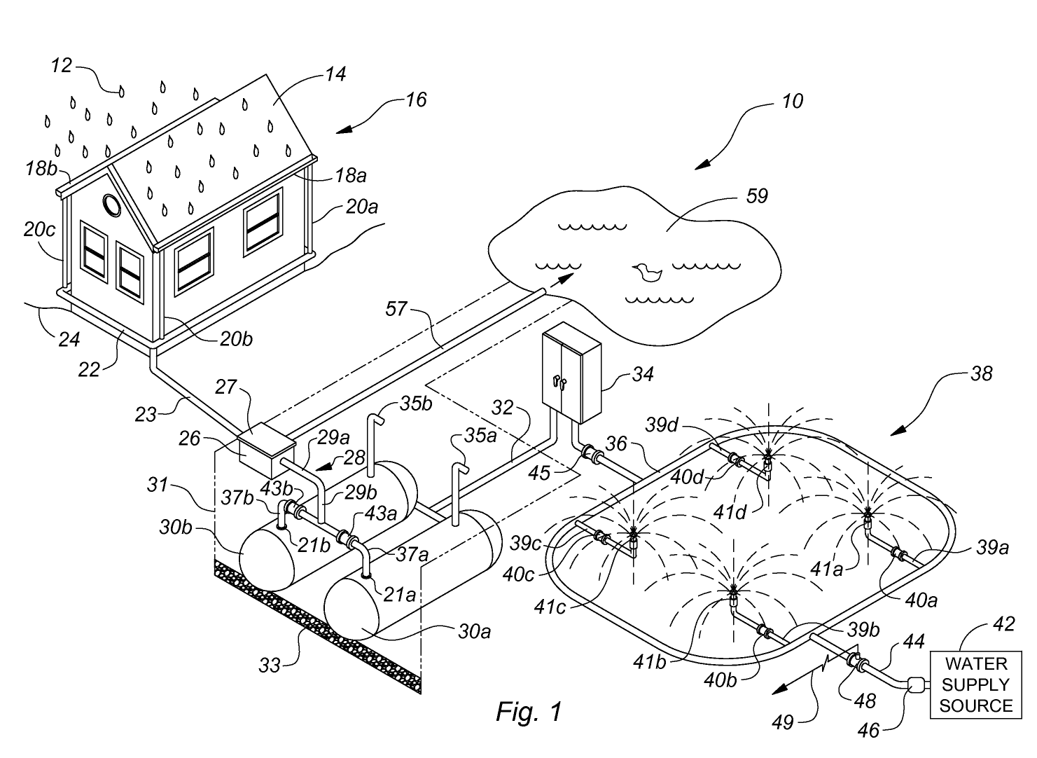

FIG. 1 illustrates an overview of an exemplary embodiment 10 of the invention. Specifically, FIG. 1 is a side perspective view of elements of the exemplary embodiment 10 in a possible environment. FIG. 1 includes cut-away portions to show elements of the exemplary embodiment that are buried in whole or in part in the ground. After this overview, description and illustration of other embodiments and aspects of the invention follow below in connection with the other figures. Further, like numbers refer to like elements and actions across the figures. Moreover, the singular covers the plural and vice versa unless specifically noted.

As shown in FIG. 1, rain 12 falls on the roof 14 of a structure 16. Only one structure is shown in FIG. 1, but more may be used in other embodiments. This embodiment is constructed to collect as much rainwater 12 as possible from the rainwater 12 hitting the roof. Other embodiments may be configured to collect less rainwater 12 such as rainwater 12 from half of the roof. The principles of the invention as explained in connection with the example 10 of FIG. 1 also apply to the other embodiments.

The rain 12 is diverted from the roof 14 to a system of gutters 18a, 18b. The gutters 18a, 18b may be equipped with screens or other mechanisms (not shown) to pre-screen items from or to filter the rainwater 12. The gutters 18a, 18b are connected respectively to downspouts. Only three downspouts are visible in FIG. 1, but fewer or more may be used in other embodiments. The rain 12 flows from the downspouts 20a, 20b, 20c into a collection pipe 22 that is positioned to collect the rainfall from all of the downspouts. The entry points to the collection pipe 22 from the downspouts 20a, 20b, 20c may be equipped with screens or other mechanisms (not shown) to pre-screen or filter the rainwater 12.

If the downspouts surround the structure 16, the collection pipe 22 also may surround the structure 16 so as to collect rainwater 12 from all of the downspouts. In another embodiment, a collection pipe 22 may be provided to collect rain 12 from less than all of the downspouts of a structure. In that case, the collection pipe 22 need not necessarily surround the structure. Pipes above ground may either be unsecured or attached to the ground or the structure by pipe hangers, bands, stakes, etc.

In this example 10 of FIG. 1, the collection pipe 22 is disposed below the downspouts 20a, 20b, 20c to receive rainwater 12, but above ground level 24. Another embodiment may include the collection pipe 22 disposed below ground or partially below ground. Still yet another embodiment may include interior drains of alternately shaped roofs with piped collection systems enclosed within the structure and passing out either above or below ground or in or combination thereof.

The collection pipe 22 may be made of polyvinyl chloride (PVC) and/or any appropriate material. The collection pipe may simply be an extension of the downspout horizontally until it intersects with other downspout connections. In the exemplary embodiment these extensions of collection pipe are about 4 to 6 inches nominal diameter. The collection pipe 22 may be referred to as a “sub-header”. In the exemplary embodiment, the collection pipe 22 is about 6 to 8 inches nominal diameter.

The collection pipe 22 is referred to herein in the singular, but that does not necessarily mean that only a single pipe is involved. More than one pipe and/or other elements may be included as part of the collection pipe 22. The singular term “collection pipe” refers to the function rather than to the number of pipes and/or other elements. This same nomenclature is used throughout this document with respect to other elements such as connective pipe 23, delivery piping 28, outlet pipe 32, and delivery pipe 28, etc., unless specifically noted otherwise.

The collection pipe 22 delivers the rainwater 12 to connective pipe 23. It may be made of polyvinyl chloride (PVC) and/or any appropriate material. At its connection to the collection pipe 22, the connective pipe 23 may be equipped with screens or other mechanisms (not shown) to filter the rainwater 12. In the exemplary embodiment 10, the connective pipe 23 is about twelve inches nominal diameter, but may vary in diameter along its length.

The collection pipe 22 may be sloped at one end and/or configured otherwise so that the rainwater 12 is delivered via gravity to the connective pipe 23. An alternate embodiment may use oversized piping to provide a hydraulic gradient therein, an inverted siphon, siphon jet, vacuum, vacuum pump, in-line pump, off-line pump apparatus, a pump or other device or system to deliver the rainwater 12 from the collection pipe 22 to the connective pipe 23.

Advantageously, existing gutters and downspouts of a building may be used in connection with an embodiment of the inventions, although new gutters and downspouts may also be used. The existing downspouts may be plumbed to PVC piping as the collection pipe and connective pipe. The PVC piping from gutters and downspouts may range in size from four inches to eight inches in diameter, and/or other sizes as appropriate to the configuration of the embodiment for the environment.

Where gravity is used to move the collected rainwater 12 in an embodiment of the invention, the PVC piping may be laid at the continuous slope of about ⅛ inch per foot of fall to insure positive flows, or at other combinations of slope and diameter as appropriate. The piping may be designed to conduct flows of anywhere between 0.05 to 0.17 cfs (in 4-inch size), 0.22 to 0.59 cfs (in 6-inch size), to 0.62 to 1.04 cfs (in 8-inch size) of collected rainwater 12, although other than the preferred embodiment pressurized or higher head systems may be used which conduct flows at higher levels. Preferably, the piping and other elements of an exemplary embodiment are engineered to accommodate flow rates of rainwater 12 that do not impair drainage of the roof of the structure.

In this embodiment 10, the end of the connective pipe 23 connected to the collection pipe 22 is higher in elevation than the other end of the connective pipe 23, which is connected to a filter system 26. The downward slope of the connective pipe 23 allows the rainwater 12 to flow from the collection pipe 22 through the connective pipe 23 to the filter system 26 without the need for pumping or other assistance. In other words, the connective pipe 23 provides an outfall of the rainwater 12 to filter system 26. The rainwater 12 is directed by gravity due to the respective slopes of the collection pipe 22 and the connective pipe 23 away from the structure 16 towards the filter system 26. In this first embodiment, the connective pipe 23 is located partially above ground level 24 at its connection to the collection pipe 22, but then continues underground to its connection with the filter system 26. Other embodiments may vary. Moreover, other embodiments do not have to rely on gravity or not totally rely on gravity to deliver the rainwater 12 to the filter system 26, but may use a siphon, vacuum pump and/or other device or system.

Still referring to FIG. 1, at its exterior connection to the connective pipe 23, the filter system 26 may be equipped with screens and/or other mechanisms (not shown) to filter the rainwater 12. In this embodiment 10, the filter system 26 is positioned with its top 27 at or just below ground level. The remainder of the filter system 26 is positioned below ground level including the exterior connection of the filter system 26 to the connective pipe 23 on one side of the filter system 26 and the connection of the filter system 26 to the delivery piping 28 on the other side of the filter system 26. The filter system 26 may be configured to be rated as 0.05 to 0.17 cfs (in 4-inch size), 0.22 to 0.59 cfs (in 6-inch size), to 0.62 to 1.04 cfs (in 8-inch size). The filter system is watertight.

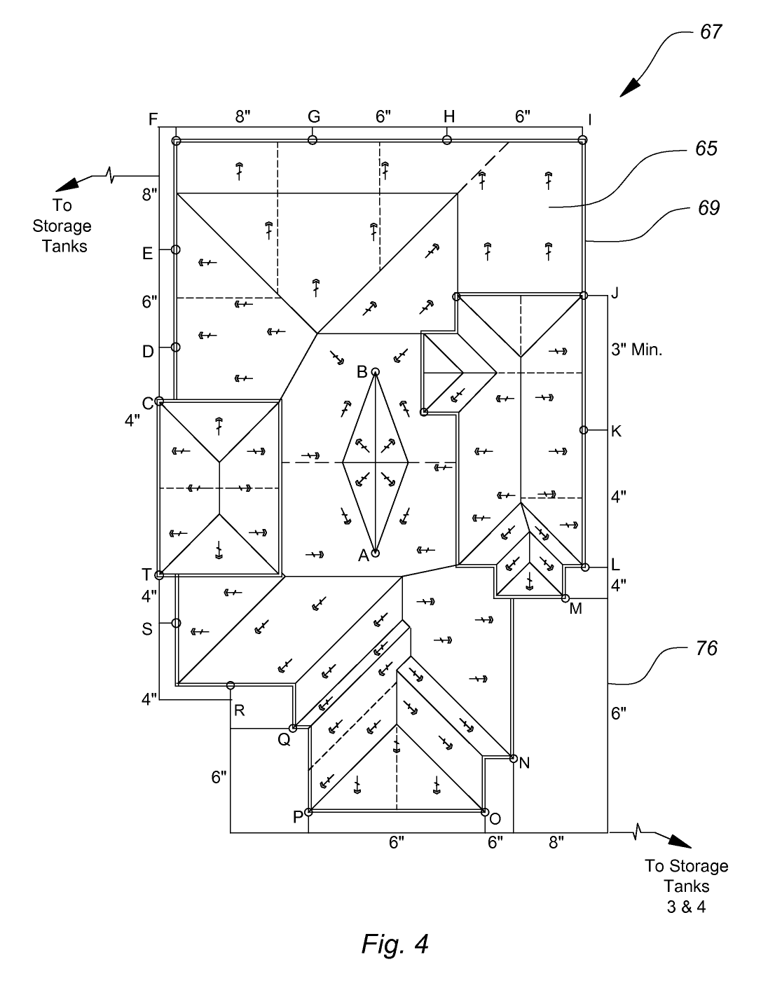

Advantageously, the position of the top 27 of the filter system 26 at ground level allows users to access the filter system 26. For example, a top that is at ground level may cover an exemplary filter system. A user may open the top of the filter system 26 to remove debris accumulated by the one or more filters inside the filter system 26. See discussion associated with FIGS. 4-6 for more details. Other embodiments may vary in terms of positioning of the filter system 26.

The exemplary filter system 26 includes an overflow pipe 57 that leads to an overflow pond 59, ditch, swale, stream, lake, river, etc. Advantageously, if the rainwater 12 it receives overwhelms the filter system 26, the rainwater 12 is diverted out of the filter system 26 into the overflow pipe 57 and then to the overflow pond 59. In this manner, the exemplary embodiment 10 may prevent rainwater 12 backup on the roof 14 of the structure 16, the gutters 18a, 18b and the downspouts 20a, 20b 20c, etc. Instead of backing up, the extra rainwater 12 is diverted to the overflow pipe 57 and thus to the overflow pond 59.

After the rainwater 12 passes into the filter system 26, it carries out its eponymous function before the rainwater 12 is delivered via delivery piping 28 to a storage system such as storage tanks 30a, 30b in this embodiment. Other embodiments may vary. The connection between the filter system 26 and the delivery piping 28 is watertight. Again, in this embodiment 10, the rainwater 12 is delivered from the filter system 26 to storage tanks 30a, 30b via gravity because the inlet to delivery piping 28 is higher than its outlet to the storage tanks 30a, 30b. Other embodiments may vary in having a pump, and/or other device or system in delivering the rainwater 12 from the filter system 26 to the storage tanks 30a, 30b. Delivery piping 28 is buried underground, but above the storage tanks 30a, 30b. Advantageously, the delivery piping 28 is configured so that the rainwater 12 is delivered from the filter system 26 at about the same rate to each of the openings or inlets 21a, 21b of storage tanks 30a, 30b. In particular, in this embodiment, the configuration that delivers about the same amount of rainwater 12 to the storage tanks 30a, 30b is delivery piping 28 that includes storage tank delivery piping 37a, 37b of about the same diameter and length to each of the two storage tanks 30a, 30b.

More particularly described, in the exemplary embodiment shown in FIG. 1, at least part of the delivery piping 28 receiving the rainwater 12 from the filter system 26 is positioned below the filter system 26 so the delivery piping 28 may receive the rainwater 12 from the filter system 26 via gravity. The first part 29a of delivery piping 28 runs generally horizontally and parallel with the bottom of the filter system 28. The first part 29a is connected to a substantially vertical extension 29b of the delivery piping 28. The vertical extension 29b connects to the midpoint of a substantially horizontal part 37a, 37b of the delivery piping 28. Horizontal part 37a, 37b connects at its respective ends to inlets in or substantially near the top of each of the storage tanks 30a, 30b. Thus, the rainfall enters the storage tanks 30a, 30b at about the same rate and volume out of the respective ends of the horizontal parts 37a, 37b. In other words, the delivery piping 28 is configured so that the storage tanks 30a, 30b fill about at the same rate so that the amount in each of the tanks 30a, 30b is about the same. Other embodiments may use different or additional processes and mechanisms for substantially ensuring that the water flows into each of the storage tanks with which the filter system 26 is associated at about the same rate and volume. Alternatively, another embodiment may first add rainwater 12 to one tank and then the other(s), or add rainwater 12 to multiple tanks in other ways.

An optional feature of this exemplary embodiment 10 is the inclusion of cutoff-valves 43a-b disposed on respective storage tank delivery piping elements 37a, 37b. The cutoff-valves 43a-b may be controlled from ground level by cutoff-valve valve stem assemblies (not shown in FIG. 1) (also referred herein as connectors). The cutoff-valves 43a-b allow the storage tank delivery piping elements 37a, 37b to be closed so that no rainwater 12 may enter the storage tanks 30a, 30b. Both cutoff-valves 43a-b do not need to be operated at the same time. For example, cutoff-valve 43a may be open while cutoff-valve 43b is left closed. In the latter case, the amount of rainwater 12 in the two storage tanks 30a, 30b is likely to vary because one of the cutoff-valve 43a allows for rainwater 12 to flow to its storage tank 30a, while the other cutoff-valve 43b does not.

In this embodiment 10 of FIG. 1, the storage tanks 30a, 30b are positioned in an excavation 31 of ground that is shaped generally as a rectangular box and that has a substantially flat bottom. The ground excavation 31 is big enough to contain at least the two storage tanks 30a, 30b and the delivery piping 28. In the example 10, the excavation 31 is about 40 feet×50 feet with a depth of about 11 feet. The sidewalls of the excavation may be stepped to comply with Occupational Safety and Health Administration (OSHA) of the United States federal government safety standards to maintain worker safety.

In the embodiment 10 shown in FIG. 1, the environment for burial of the storage tanks 30a, 30b is taken into consideration. For example, the ground water table conditions are taken into account with respect to the buoyancy and flotation aspects of the storage tanks 30a, 30b. These tank buoyancy and flotation calculations for the embodiment 10 of FIG. 1 reveal that the soil burying the storage tanks 30a, 30b is sufficient ballast to counteract possible buoyancy or flotation effects. An initial 1,000 to 2,000 gallons of water may be introduced into each storage tank 30a, 30b for ballasting. Alternative embodiments, however, may require that straps and anchors anchor the storage tanks

An alternate embodiment in high ground water conditions where flotation and buoyancy are concerns, may involve drilling the bottoms of storage tanks to pre-determined size for installation of anti-flotation pressure relief valves in a sufficient quantity and arrangement to pass ground water into the storage tanks in order to ballast the storage tanks against vertical movement by the hydrostatic pressure. Still yet another embodiment is to structurally anchor the tank with steel, concrete, or wooden materials including dead-men, straps, anchors, cables, etc.

Besides the excavation 31 of ground, there is a further excavation in the form of a hole 73 that is dug below the level of the excavation 31 to accommodate the pump 58 described below.

Bedding material 33, in this case, clean granular material (sand), is disposed on top of the bottom of the excavation 31. The bedding material 33 in exemplary embodiment 10 amounts to about a foot in depth. The bedding material 33 may be made deep enough to reach the spring line of each tank.

The exemplary embodiment 10 of FIG. 1 shows two underground storage tanks 30a, 30b. The invention, however, should not be limited in the number or location of storage tanks For example, another embodiment may include only a single tank and that tank may be positioned above ground, including of alternate shapes and orientation. As another example, another embodiment may include two sets of two storage tanks.

The exemplary two storage tanks 30a, 30b are positioned on the bedding material 33 in the excavation 31. In this example 10, the two storage tanks 30a, 30b are of the same substantially cylindrical size and shape, but do not have to be in all embodiments of the invention. The storage tanks 30a, 30b are spaced apart from each other in a substantially parallel side-by-side configuration along their respective lengths so that the respective ends of the two storage tanks 30a, 30b are generally in the same vertical plane.

An embodiment of the inventions constructed by the inventors used former underground fiberglass gasoline single wall tanks manufactured by Xerxes Corporation, a subsidiary of ZCL Composites, Inc., 7901 Xerxes Avenue S, Minneapolis, Minn., USA, 55431. The website of Xerxes Corporation (www.xerxes.com) contains a library of information about their products including information about installation. For information relating to the installation of water storage tanks, see Roof-Reliant Landscaping, Rainwater 12 Harvesting with Cistern Systems in New Mexico, Nate Downey, Author, New Mexico Office of the State Engineer, www.ose.state.nm.us, 2009.

A storage tank may be referred to herein as storage, tank, cistern, or storage system.

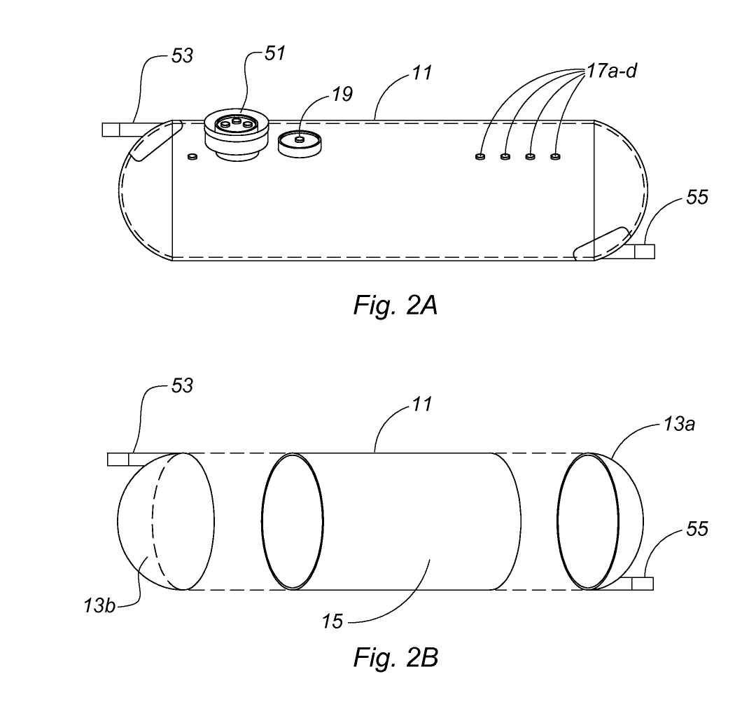

FIG. 2a is a side view of an exemplary single walled petroleum tank 11 such as may be used with the exemplary embodiment 10. A problem with the petroleum tank 11 for its use as a storage tank is that the petroleum tank 11 includes very small diameter piping and also included piping with pressure fittings. Changes are made to the petroleum tank 11 to convert it to a storage tank as appropriate to an exemplary embodiment 10 of the invention.

An exploded view of the exemplary tank 11 is shown in FIG. 2b. To make use of the tank 11 in the exemplary embodiment 10, the tank 11 is cleaned and other changes made to it. The cleaning and other changes may be better accommodated by separation of the ends (also referred to as “tops”) 13a, 13b of the tank 11 from the main body 15 of the tank 11. After cleaning and the other changes, the ends 13a, 13b and the main body 15 of the tank 11 are re-connected in a watertight manner. The changes that are made to tank 11 are such that allow the tank 11 to be used as a storage container for rainwater 12 used for irrigation. For example, the gasoline piping connections 17a-d, 19 on the tank 11 are closed. Cracks and other abrasions are repaired so the tank 11 is watertight. If the tank 11 includes a manhole 51 such as shown in FIG. 2a, the manhole 51 may be made to be watertight or may be eliminated. Connections to the tank 11 for use as a storage tank are made watertight.

A drain port 53 is added as an inlet to a cutout performed at the top and one end of the tank 11. Another drain port 55 is added as an outlet to a cutout performed at the bottom and other end of the tank 11. With respect to each drain port 53, 55, a hole or opening is made in the tank 11 to accommodate the drain ports 53, 55. The holes in the exemplary embodiment 10 accommodate drain ports eight inches in nominal diameter. Each of the drain ports 53, 55 are configured for use with the fiberglass tank as follows: a pipe of about eight inches in diameter is formed from aluminum; and an activated fiberglass material is wrapped around the aluminum pipe in a fixed manner. The drain ports 53, 55 are affixed to the tank 11 in a watertight manner with the fiberglass of the drain ports 53, 55 making a sealed connection with the fiberglass of the tank 11. The additional fiberglass added to tank 11 around drain ports 53, 55 adds additionally reinforcement plate value to the modified tanks where cut-outs were removed. Other piping, such as PVC piping, may be connected to the drain ports 53, 55 by watertight coupling.

The Xerxes tanks, as noted, are primarily single wall tanks, but other tank and wall thickness configurations may be used. The Xerxes tanks are about eight feet in diameter and thirty feet in length. Each Xerxes tank is capable of holding up to about 10,000 gallons of water.

Referring again to FIG. 1, each of the two storage tanks 30a, 30b has at least a vent pipe 35a, 35b with a watertight connection at one end to an opening in the top of its storage tank 30a, 30b. Connection to the top of the storage tank 30a, 30b allows vent pipe 35a, 35b access to the interior of the storage tank 30a, 30b. The other end of each vent pipe 35a, 35b is positioned above the excavation 31 and above ground in open-air. The open-air end of each vent pipe 35a, 35b has an opening (not shown) to vent air from the interior of its respective storage tank 30a, 30b to the open-air. The air opening of the vent pipe 35a, 35b may be covered with a screen or other device to keep out debris or other material.

As noted, the rainwater 12 may be stored in the storage tanks 30a, 30b. Generally, the exemplary embodiment 10 stores about the same amount of curved wall 91 in each of its two storage tanks 30a, 30b. The same amount is stored because as noted above, the rainwater 12 is delivered to the storage tanks 30a, 30b at about the same rate by the delivery piping 28 from the filter system 26. Advantageously, the exemplary embodiment 10 has a delivery system 32 for providing the rainwater 12 to an irrigation system 38, which further affords communication of fluid flows between tanks and thereby equalizes storage capacity by gravitational effects.

As an optional embodiment, the storage tanks may be alternately relocated and reconfigured as integral elements of the structure served, including tanks mounted within structural elements, above or below floors, by formation of equivalent storage basins, chambers, caverns, or vaults as formed by the structural members themselves, etc.

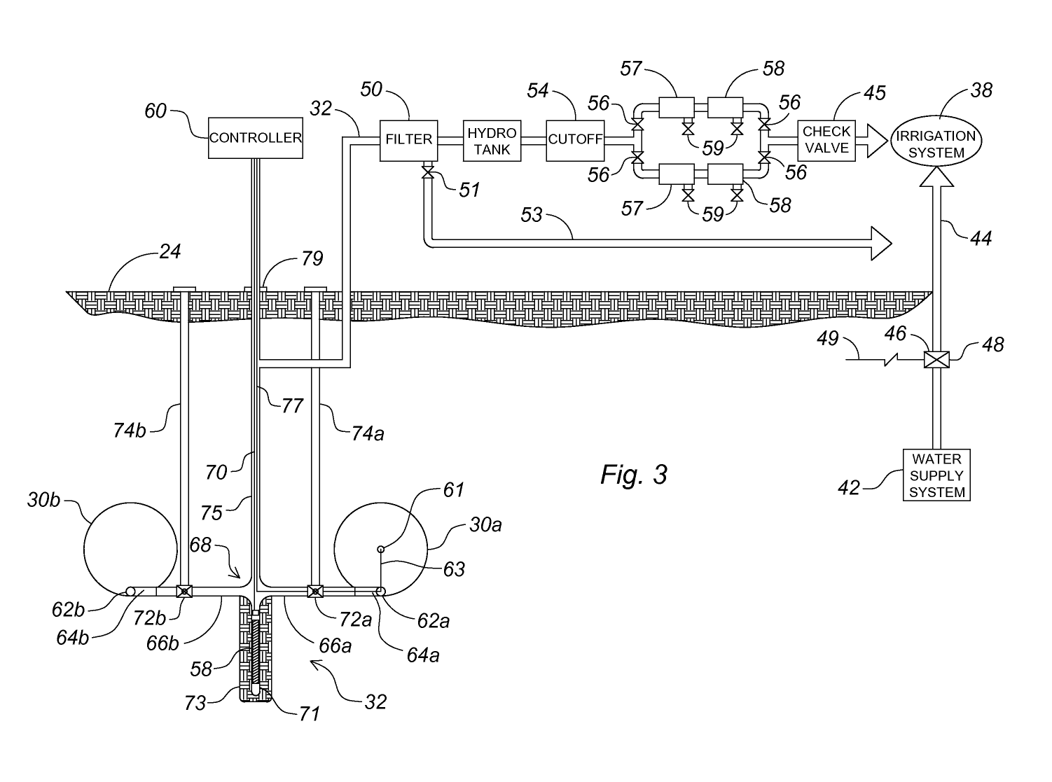

Referring again to FIG. 1, when irrigation with the stored rainwater 12 is to take place, the rainwater 12 exits the two storage tanks 30a, 30b at about the same rate of flow. The rainwater 12 is transported via a distribution system to the irrigation system. In this embodiment, the rainwater 12 is pumped through a distribution system that includes the irrigation delivery piping system 32 (shown only in part in FIG. 1), and also through another filter 50 (not shown in FIG. 1) and a hydropneumatic tank 52 (not shown in FIG. 1) to the irrigation system 28. A hydropneumatic tank also may be referred to herein as a hydro tank. Further details about the filter and the hydropneumatic tank are provided below in connection with FIG. 3. FIG. 1 shows a shed 34, which in addition to its storage function, advantageously, may shield the elements within from ultraviolet light and heat created by sunlight. The shed 34 houses at least the filter 50 and hydropneumatic tank 52 in this embodiment. The shed therefore serves purpose of minimizing microbiological growth within the piping, opaques, translucent, transparent components. Other embodiments may vary.

More particularly, the rainwater 12 may pass out of the storage tanks 30a, 30b into the irrigation delivery piping system 32 of the distribution system. With the help of a pump 58, the rainwater 12 is pumped through the irrigation delivery piping system 32 to an irrigation system 38. In the preferred embodiment, an in-pipe vertical well pump is used as contained in recessed pipe wet well cavity, thereby allowing full depletion of each tank. Mechanisms other than a pump and/or in combination with a pump may be used to facilitate transport of the rainwater 12 from the storage tanks 30a, 30b to its destination. The rainwater 12 continues to be transported from its storage in storage tanks 30a, 30b to the irrigation system 38 so long as there is rainwater 12 in the storage tanks or until an operator terminates the delivery of the rainwater 12 to the irrigation system 38 by a signal to a controller 60 that may result in turning off the pump 58 (if that is an option), closing the valves on the outlets (not shown in FIG. 1) of the storage tanks 30a, 30b (if that option is available), and/or otherwise.

FIG. 1 also shows a check valve 45 on the irrigation delivery piping system 32 between the shed 34 and the irrigation system 38. The check valve 45 does not allow flow of water in the opposite direction from the irrigation system 38 to the irrigation delivery piping system 32. Thus, the check valve 45 precludes the filling of the storage tanks 30a, 30b by the water supply source 42. An alternate embodiment may consist of removing the check valve to allow communication of the tanks with the water supply source to afford increased certainty of available water storage in tanks at all times for irrigation purposes, including expected periods of drought.

The irrigation system 38 shown with the embodiment 10 of the invention in FIG. 1 is a loop irrigation system having a main line 36 disposed in a generally rectangular shape. From the main line, sprinkler pipes 39a-d are disposed into the interior of the generally rectangular shaped layout created by the main line 36 of the irrigation system. The sprinkler pipes 39a-d connect respectively to sprinklers 41a-d also disposed within the interior of the main line 36. Each sprinkler pipe 39a, 39b, 39c, 39d may include a valve 40a-d to cut off water delivery to the sprinklers 41a-d.

Advantageously, the exemplary embodiment 10 provides for the situation when there is no rainwater 12 stored in the storage tanks 30a, 30b. In that case, water is supplied to the irrigation system 38 by a water supply source 42 such as a municipal water supply utility. A water supply source is also referred to as a “water source” or “water supply” herein. The water supply source 42 is connected to the irrigation system 38 by piping 44, which also may be referred to as “piping connection”. The piping 44 may include a back flow preventer 46 to prevent reverse flow of the water from the embodiment 10 to the water supply source 42. The embodiment 10 also includes a solenoid valve 48 on piping 44 that is closed when the irrigation system 38 is fed by rainwater 12 from the storage tanks 30a, 30b, and that is open when the irrigation system 38 is fed by the water supply source 42. The solenoid valve 48 also may be referred to as the “water supply source valve”, “valve”, or “inter-connect valve”. The solenoid valve 48 includes a connection 49 to controller 60 so that the controller may cause the solenoid valve 48 to open or to close. When the solenoid valve 48 is open to allow water from the water supply source 42 to be used for irrigation, the check valve 45 on the storage tank side of the irrigation system 38 is closed. By closing the check valve 45, the water from the water supply source 42 does not enter the exemplary embodiment, and in particular, does not fill the storage tanks 30a, 30b.

Advantageously, in the exemplary embodiment 10, a commercial irrigation water meter (not shown) is positioned with respect to the solenoid valve 48. The commercial irrigation water meter is separate from the exemplary embodiment's convention water meter. The commercial irrigation water meter keeps track of the water used by the irrigation system 38 from the water source. The cost for the water used by the irrigation system 38 is less than potable water supplied by the water source at least because sewage fees are not applied to the water; however, metering may also be a function of water utility in area applied, and some utilities may not differentiate between irrigation and consumption metering.

FIG. 3 illustrates elements of the same exemplary embodiment 10 described above in connection with FIG. 1 except that FIG. 3 shows the rainwater 12 exit side of the storage tanks 30a, 30b and elements associated with delivery of the rainwater 12 from the storage tanks 30a, 30b to the irrigation system 38. In other words, FIG. 3 shows the back of the storage tanks 30a, 30b.

Each of the storage tanks 30a, 30b includes a hole 62a-b for releasing the stored rainwater 12. The holes 62a-b are located on the bottom of their respective storage tanks 30a, 30b so that the rainwater 12 may be released via gravity through the holes 62a-b. In the exemplary embodiment 10, the holes 62a-b are each about 8 inches in diameter. Also, the holes 62a-b are positioned near one end of the storage tanks 30a, 30b while the inlets 21a, 21b to the storage tanks 30a, 30b are positioned on top and at the other ends from the holes 62a-b. Other embodiments may vary in placement of inlets, outlets, or both.

The holes 62a-b may include respective valves (not shown) to control the storage or release of the rainwater 12. The valves may be activated through a connection (not shown) that runs through the piping discussed below to a controller 60.

Outlets 64a-b are connected in a watertight fashion to each respective hole 62a-b. The outlets 64a-b compare to the drainpipe 55 discussed in connection with FIGS. 2a, 2b. The outlets 64a-b are about eight inches in diameter and are mitered and have a length of about 24 inches more or less.

The outlet 64a-b of each storage tank 30a, 30b includes a watertight connection to an outlet pipe 66a-b. Each outlet pipe 66a-b is about 8 inches in diameter and is about 24-36 inches long. Other configurations may vary.

In this embodiment 10, the outlets 64a-b and outlet pipes 66a-b share a common longitudinal axis, and are disposed generally perpendicularly in a horizontal manner to the longitudinal axes of the storage tanks 30a, 30b. The outlet pipes 66a-b point towards each other. The outlet 64a from one tank 30a and its outlet pipe 66a may be referred to as an “arm” of piping. The outlet 64b from the other tank 30b and its outlet pipe 66b may be referred to as the other “arm” of piping. The overall size, shape, and length of outlet 64a and outlet pipe 66a are about the same as the overall size, shape, and length of outlet 64b and outlet pipe 66b. In other words, the piping arms are about the same. Given that the “arms” of the piping are about the same, the rainwater 12 exits the arms at about the same rate to irrigation delivery piping system 32, which is the following element in the process of delivering the rainwater 12 to the irrigation system.

Next is explained the manner in which the outlet pipes 66a-b connect to a pipe socket 71 housing a pump 58 and to irrigation delivery piping 75. These four elements (outlet pipes 66a-b, pipe socket 71 and irrigation delivery piping 75) are connected in a “plus sign” or “cross” shape 68 as is explained next.

Between the storage tanks 30a, 30b, a hole 73 is dug into the ground. The hole 73 is about halfway between each of the storage tanks 30a, 30b. The hole 73 is deep enough and wide enough to receive the pipe socket 71. In the exemplary embodiment 10, the hole 73 is about five feet deep. The pipe socket 71 may be a well casing pipe such as is used in residential water supply. A pump 58 is dropped into the pipe socket 71. The pump 58, in the exemplary embodiment 10, is about three feet long, which explains the need for the hole 73 to be more than three feet deep. Further, the pipe socket 71 preferably may be closed at its bottom as shown in FIG. 3. The bottom of the pipe socket 71 may rest on or be supported by a footing in some embodiments.

The pipe socket 71 housing the pump 58 forms the lower vertical arm of the plus shaped intersection 68. The horizontal arms of the intersection 68 are formed by the outlet pipes 64a-b from the storage tanks 30a, 30b. The irrigation delivery piping 75 forms the top vertical arm of the “plus” or “cross” shaped piping intersection 68.

When the excavation 31 is filled in, a recess cavity 77, also referred to as “area”, around the irrigation delivery piping 75 is left open in the exemplary embodiment at least from the plus shaped intersection 68 to ground level 24. The recess cavity 77 is made large enough in the exemplary embodiment 10 to allow for removal of the pump 58 for service or replacement, or to clean the pipes, etc. The area recess cavity is capped 79 at ground level. The cap 79 may be removed, or opened to access the area 77. The cap 79 may be lockable.

The irrigation delivery piping 75 may deviate from its vertical position in the recess cavity 77 to run the pumped rainwater 12 through another filter 50, a hydro tank 52 as is explained further below. Embodiments may vary.

Reference now is again made to the plus shaped intersection 68. When the rainwater 12 is to be used for irrigation, the rainwater 12 leaves the storage tanks 30a, 30b via their respective holes 62a-b, outlets 64a-b, and outlet piping 66a-b, and flows to the “plus” shaped piping intersection 68. The rainwater 12 falls into the pipe socket 71. The pump 58 activates and powers the rainwater 12 into the irrigation delivery piping 75 of the irrigation delivery piping system 32 for ultimate delivery to the irrigation system 38.

In this embodiment, the pump is a Grundfos SP, Model Number 25s15-9, 230 VAC, 3-Phase submersible 1.5 horsepower (hp) vertical pump. It also may be referred to as a “submersible well pump”. In the exemplary embodiment, the pump has an air tight sealed motor with the pump. It is sized to work with the pair of 10,000 gallon storage tanks 30a, 30b so that the pump 58 moves the rainwater 12 along and hydro tank 52 (explained below) pressurizes the rainwater 12 to 35-85 psi.

The pump 58 may automatically activate when the rainwater 12 enters the “plus” shaped piping intersection 68, and in particular, enters the pipe socket 71 in which the pump 58 is disposed vertically. The pump 58 may stop automatically when rainwater 12 is not present in the pipe socket 71 housing the pump 58.

In an embodiment, the pump 58 may be activated or deactivated by a controller 60 through communication connection 70 shown in FIG. 3. The communication connection 70 may run from the pump 58 through part of the irrigation delivery piping system 32 to the controller 60, which is located above ground. The communication connection 70 allows the controller 60 to turn on and to turn off the pump 58. The controller 60 may be mechanical, electrical, pneumatic, electronic and/or any configuration that allows the controller 60 to carry out appropriate control functions.

The exemplary pump 58 also may include an electrical connection (not shown in FIG. 3) positioned similarly to the communication connection 70 to connect to a power source (not shown in FIG. 3).

Advantageously, the positioning of the pump 58 with respect to the pipe 32 into which the rainwater 12 is moved from the storage tanks 30a, 30b obviates the need for more than one pump. For example, another embodiment may use a submersible pump inside a storage tank to assist the rainwater 12 in moving from the storage tank through piping to the irrigation system 38. In that case, however, a submersible pump would have to be disposed in each of the storage tanks used. In the exemplary embodiment shown in connection with FIG. 3, only a single pump is used. Of course, additional pump(s) may be used with the embodiment described in connection with FIG. 3. Moreover, placement of a pump in each of the storage tanks would reduce the capacity of the storage tank for rainwater 12.

There are other advantages to having pump 58 positioned outside the storage tanks 30a, 30b. With the pump 58 outside the storage tanks 30a, 30b, unlike the use of submersible pumps inside the storage tanks 30a, 30b, the storage tanks 30a, 30b may be run completely dry. All of the rainwater 12 may be used for irrigation.

Another embodiment of the pump location and configuration is available by conjoining the pump socket 71 to a tank outlet 64a-b or to a tank 30a, 30b directly, and thereby allowing the interior of tank to service same purpose as recess cavity 77, and repositioning delivery piping 75 to the top side of that tank. Under this alternate configuration only one tank of a multiple tank placement would need to be so modified, allowing the creation of a pre-manufactured “pump tank” versus other available “storage tanks” By further integrating the pump controller and float switch with pre-wired and pre-plumbed hydro tank and controls are installed on designated pump tank unit, such that a pre-manufactured “package unit” may therefore be available. The package unit may be commercially sized and rated by the storage capacity, high service pump flow volume, etc.

The exemplary embodiment 10 provides a system for letting the controller 60 know when the storage tanks 30a, 30b are empty or dry and when the storage tanks 30a, 30b contain water. In the exemplary embodiment 10, one of the tanks includes an empty indicator. In this embodiment, the empty indicator is a float switch 61 inside the tank 30a. Other embodiments may vary. The float switch 61 is communicatively connected via connection 63 to the controller 60. As shown in FIG. 3, the float switch is communicatively connected via connection 63 that runs from the float switch 61 out the hole 62a and outlet pipe 64a of the storage tank 30a. The connection continues to the controller 60 either through the area 77 or the irrigation delivery piping 75 from which the connection 63 exits to connect to the controller 60.

As its name implies, the float switch 61 floats on top of the water in the tank 30a. When the tank 30a is empty, the float switch 61 signals (via connection 63) the controller 60 when the tank 30a is empty. As noted with respect to the exemplary embodiment 10, the water levels in the two storage tanks 30a, 30b are about the same. So, when one tank 30a is empty, the other tank 30b is empty as well. Thus, only one float switch 61 informs the controller 60 that both storage tanks 30a, 30b are empty. Another embodiment, however, may use a float switch in each tank.

In the exemplary embodiment 10, if irrigation is to be carried out, the controller 60 responds to the empty signal from the float switch 61 by turning off the pump 58 and opening the solenoid valve 48 to the water supply source 42. The controller 60 causes the solenoid valve 48 by sending a signal to the solenoid valve. Thus, The result of opening the solenoid valve 48 is that water from the water supply source 42 provides the water for the irrigation system 38.

Reference is now made again to FIG. 3 and elements of the exemplary embodiment 10 relating to the exit of the stored rainwater 12 from the storage tanks 30a, 30b. In particular, exemplary embodiment 10 includes two cutoff-valves 72a-b disposed respectively on the outlet piping 66a-b that carry the rainwater 12 from the outlets 64a-b of the storage tanks 30a, 30b. The cutoff-valves 72a-b connect to valve stem assemblies 74a-b, which are positioned respectively between the cutoff-valves 72a-b and ground level 24. The valve stem assemblies 74a-b also may be referred to herein as “valve stems” or “connectors”. A user may access the valve stem assemblies 74a-b at ground level and cause the cut-off valves 72a-b, respectively, to open or close. For example, a user may use a T-handled wrench to affect the closure of the valves 72a-b. When the cutoff-valves 72a-b are open, the rainwater 12 may be transported to its ultimate destination of the irrigation system 38. If the cut-off valves 72a-b are closed, however, the rainwater 12 is blocked from reaching the irrigation system 38. An embodiment of the invention may be configured to include the cut-off valves 72a-b with their respective valve connectors 74a-b, and not include the valves on the holes 62a-b of the storage tanks 30a, 30b.

An advantage of including the cutoff-valves 72a-b is in the case of failure of one or both of the storage tanks 30a, 30b. For example, assume storage tank 30a were cracked and failed and allowed unfiltered ground water to seep into it, or the filtered rainwater 12 to escape out. Cutoff-valve 72a may be closed to prohibit the transportation of the unfiltered ground water or the filtered rainwater 12 through the exemplary embodiment 10.

Once the rainwater 12 is pumped, it continues through the irrigation piping delivery system 32 until it reaches a filter 50, where the rainwater 12 is (again) filtered. The filter 50 may be located above ground such as in the shed 34 shown in FIG. 1. In the exemplary embodiment 10, the filter 50 is a hydrodynamic centrifugal filter (also referred to as a hydrodynamic separator, grinder, grinding filter, polishing filter, or a super filter). The filter 50 may remove particulates of the debris that have not previously been filtered out of the rainwater 12. The filter 50 may filter particulates of about 70-90 microns. One or more progressive polishing filters also may be used or instead. This final filtering may remove even smaller particulates than the earlier filtering. As a result, the accumulation of debris, which could clog the irrigation system, may be avoided. Advantageously, the harvested filtered stored rainwater 12 may be used with micro jet irrigation system spray heads because the filter functions are thorough enough to allow for such usage.

The exemplary embodiment 10 uses a SandMaster sand removal separator available from Lakos Separator and Filtration Solutions, www.lakos.com. The Lakos website includes information on how to determine sizing of the separator as well as other information.

Referring again to FIG. 3, after the stored rainwater 12 passes through the filter 50 on its way to the irrigation system 38, the stored rainwater 12 passes through a hydro tank 52, which may be referred to as a hydropneumatic water tank, well tank, or pressure tank. The hydro tank 52 may be located above ground such as in the shed 34 shown in FIG. 1. Among the functions of the hydro tank 52 is to deliver the rainwater 12 in a preset pressure range of from 35-85 psi. Advantageously, the hydro tank may monitor or coordinate with the pump 58 and prevent it from turning on too often. Yet another function of the hydro tank 52 is that it may buffer or lower pressure surges, much like a power surge protector.

The exemplary embodiment 10 uses a WellXtrol hydro tank available from Amtrol Inc. Information on the WellXtrol hydro tank may be obtained from www. amtrol. com.

After passing through the hydro tank 52, the rainwater 12 continues on its path to the irrigation system 38 unless a cutoff valve 54 has been activated. In the exemplary embodiment 10, the cutoff valve 54 is located above ground level 24 (such as in shed 34 shown in FIG. 1) so that it may be readily accessed for activation or de-activation. In the exemplary embodiment, the cutoff valve 54 is manually operated, but other embodiments may vary.

As a final element prior to delivery of the rainwater 12 to the irrigation system 38, the exemplary embodiment 10 includes a check valve 45. It may also be referred to as a clack valve, a non-return valve or a one-way valve. The check valve 45 is used to prevent water from flowing in reverse to what has been described in connection with the irrigation delivery system 32. For example, the check valve 45 does not allow water from the water supply source 42 to flow through to fill the storage tanks 30a, 30b.

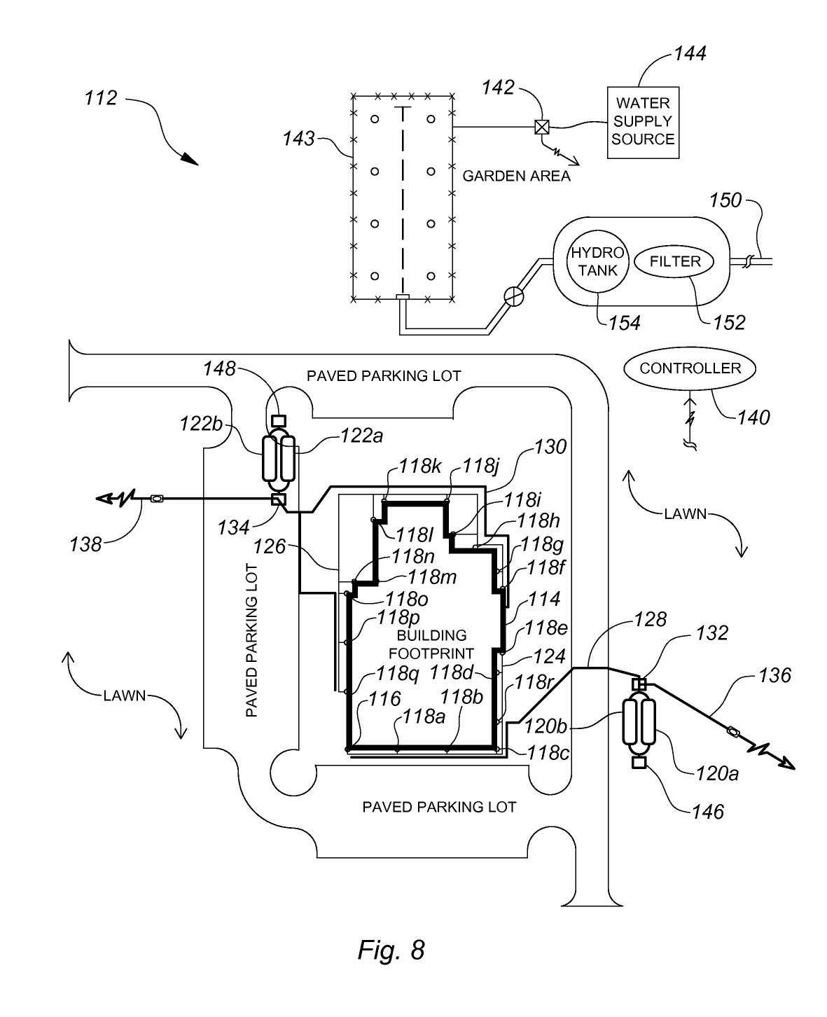

Some of the embodiments of the invention mentioned above use only a single storage tank, but the single tank may range in size from very small to very large. Another embodiment may use two or more storage tanks as is explained below in connection with FIG. 8. Again the sizes of the storage tanks may vary from very small to very large whether all of the tanks are of the same size in an embodiment, or whether the tanks in an embodiment vary between or among themselves.

If an embodiment includes more than one storage tank, then the embodiment also may need to include related elements to accommodate the inclusion of more than one storage tank. Similarly, the size of the storage tank(s) in an embodiment may require accommodation in size, shape and/or other features of related elements such as pipes. Thus, among the first actions to implementing an embodiment of the invention is to determine the number and size of storage tank(s) to use.

There are a number of factors to consider in determining the number of storage tanks to use in an embodiment. For example, the amount of rainfall in the geographic area may need to be taken into consideration. Another factor to take into consideration is the manner in which the rainfall is shed by a particular roof. In addition, the use to which the harvested water is to be put may need to be taken into consideration in selecting the size and number of storage tank(s) used in a particular embodiment of the invention.

Advantageously, an embodiment of the invention analyzes the characteristics of rainfall such as rate, quantity, and direction of rainfall on a particular roof. Other factors may be taken into account as well. This analysis is referred to as micro contouring. The information from the analysis may be used to determine the type, number, and size of elements that may be used as part of the particular embodiment to be implemented. For example, the analysis of rainfall on a particular roof may result in the decision to use more than one storage tank. The analysis also may provide information on other elements of the system including the length of gutter required, the number and placement of downspouts, the length of perimeter piping, collection piping, and connection piping, etc.

FIG. 4 is a top view of a roof 65 of a building 67. FIG. 4 also may be referred to as a micro-contouring plan of a roof. The double line 69 in FIG. 4 indicates the perimeter of the roof 65. The solid lines within the roof perimeter 69 represent the various pitches of the roof 65. Arrows within respective pitches of the roof 65 indicate the direction of rainwater 12 diversion. In this example, the micro-contouring analysis applied to roof 65 results in a determination that four tanks deployed in pairs as served by two separate collection and connective pipe systems, filtration, storage and pumping elements are to be used in the water conservation system for this building 67.

In the example of FIG. 4, the operator desires to keep the levels of stored water balanced across four storage tanks In other words, the operator desires to keep the levels of stored water the same for all four tanks To accomplish such balanced levels, the rainwater 12 may be diverted from the roof 65 in a balanced manner taking into consideration the micro-contouring analysis of the roof. A gutter system (not shown in FIG. 4) is attached to the perimeter 69 of the roof 65. Downspouts are positioned with respect to the gutter system to accommodate the balanced distribution of the diverted rainfall to the four tanks In FIG. 4, the circles labeled with letters on the perimeter 69 of the roof 65 represent the inlets of the downspouts. Each downspout is connected at its opposite end to collection piping 76. In this example, the collection piping 76 runs around the perimeter 69 of the building 67. Thus, the collection piping 76 also may be referred to as perimeter piping 76.

In this example, the collection piping 76 is buried underground. The ends of the downspouts opposite the gutters are deployed underground to connect to the collection piping 76. It connects to connection piping (not shown in FIG. 4) that slopes downwards from the collection piping 76 to the storage tanks and other elements of the embodiment (not shown in FIG. 4). Thus, gravity facilitates the transport of the diverted rainwater 12 from the roof of the building towards the four storage tanks

As noted in the previous paragraph, the operator in that example desires to keep the levels of stored water balanced across the four tanks Having the same level of stored water in each of a system's tanks is not a requirement of the invention. In some cases, an operator may decide to have different levels between or among tanks The operator may also desire tanks of different sizes, shapes, configurations, locations, etc., to be integrated into the design to provide varied responses to multiple requirements. It is further noted that so long as additional tank space over and above that initially provided remains available that the storage capacity of system is always readily expandable.

As noted above, rainwater 12 is carried through collection pipe 22 and connective pipe 23 to filter system 26 in the exemplary embodiment 10. The filter system 26 may be any appropriate device or system that carries out its eponymous function of removing debris from the rainwater 12. The filter system 26 also may be referred to as the “filter”, the “blackbox”, the “smartbox”, or the “blackbox system” or the “smartbox system”. Many factors may have to be taken into account to determine the ultimate size of debris to be removed from the rainwater 12 by the filter system. The embodiments described herein may be able to remove debris of a size that allows the filtered rainwater 12 to be used with an irrigation system at least after it passes through filter system 26 and the filter 50. In circumstances where such fine filtering is unnecessary, the filter system may include fewer and/or different filters.

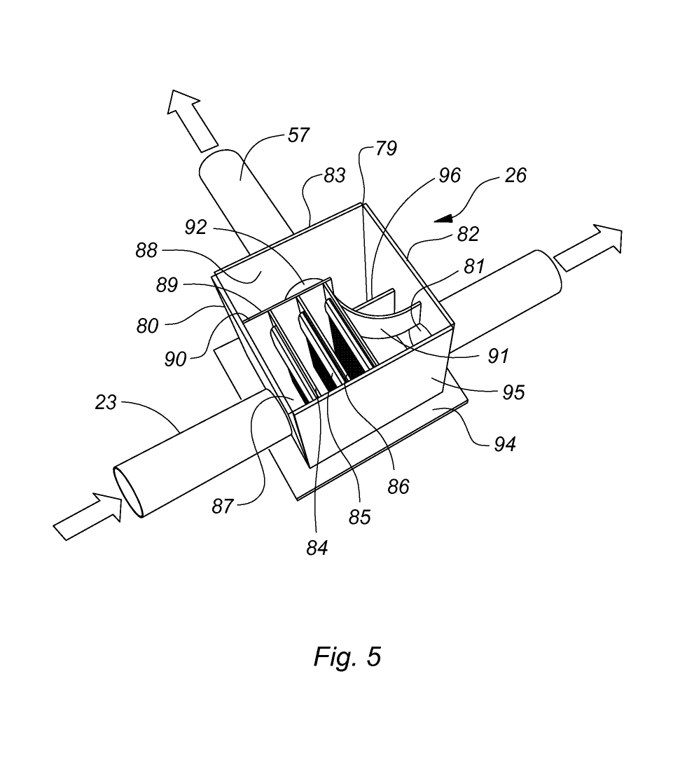

FIG. 5 is a top interior perspective view of the exemplary filter system 26 of the exemplary embodiment 10. FIG. 5 shows the filter system 26 with the top 27 removed. The filter system 26 includes a generally cube-shaped box 79 of dimensions of about 24″×24″×24″. Other embodiments may vary.

The cube-shaped box 79 includes four sidewalls 80, 82, 83, 95 and a bottom 94. Sidewalls 80, 82 are opposite to each other. Sidewalls 83, 95 are opposite to each other. Sidewalls 80, 82 are generally perpendicular to sidewalls 83, 95. Sidewall 80 may be referred to as the “entry sidewall” because the rainwater 12 enters through a hole in that sidewall 80. Sidewall 82 may be referred to as the “exit sidewall” because the filtered rainwater 12 exits through a hole 81 in that sidewall 80. Sidewall 83 may be referred to as the “overflow sidewall” because rainwater 12 overflow exits through a hole in sidewall 83.

The cube-shaped box 79 is made of shop-welded high-density polyethylene (HDPE) materials in the exemplary embodiment, but other embodiments may vary.

The cube-shaped box 79 is positioned in this embodiment in the ground with its top 27 (not shown in FIG. 5) at ground level. Advantageously, access may be had to the interior of the filter system 26 from ground level by removing or opening the top 27 of the cube-shaped box 79. The top 27 (or cover) may be opened, closed, and locked, if desired by methods including flanged bolts and nuts, drilled and tapped plastic members making use of heli-coil inserts for mating threads to bolting hardware, use of hinges, pull handles, locking hasps, etc., as used alone or in combination.

Further, in this embodiment, the cube-shaped box 79 is positioned generally horizontally parallel to the ground level 24. In some embodiments, the cube-shaped box 79 may be tilted slightly downward from its connection to the connective pipe 23 to the delivery pipe 28 to facilitate the movement of the filtered rainwater 12 via gravity.

Rainwater 12 enters the filter system 26 from the connective pipe 23, which is connected in a watertight fit around a hole in the sidewall 80 of the cube-shaped box 79 of the filter system 26. In the exemplary embodiment 10, the connective pipe 23 is connected to a hole (not shown in FIG. 5) in the sidewall 80 that is disposed in about the right one-third of the width of the sidewall 80 and at about the middle of the height of the sidewall 80. The hole is sized to accommodate the connective pipe 23. In this embodiment, the diameter of the hole is about 8 ¾ inches. With reference to the filter system 26, the connective pipe 23 also may be referred to as the “entry pipe”.

After being filtered, the rainwater 12 exits the filter system 26 on its way to be stored in the storage tanks 30a, 30b through a hole 81 in the exit sidewall 82 opposite to the entry sidewall 80. The hole 81 is connected in a watertight fit to the delivery piping 28 previously discussed in connection with FIG. 1. The hole 81 is sized to fit the delivery piping 28. In the exemplary embodiment 10, the hole 81 is about 8 ³/4 in diameter. Also in the exemplary embodiment 10, the hole 81 is disposed in about the right one-third of the width of the sidewall 82 and at about the middle of the height of the sidewall 82. With reference to the filter system 26, the delivery piping 28 also may be referred to as the “exit pipe”.

Advantageously, the filter system 26 may function more than just as a filter in the exemplary embodiment. Besides filtering the rainwater 12, the filter system 26 may act like a basin in collecting the rainwater 12 before it moves on. Thus, the filter system 26 may slow the velocity of the flow of the rainwater 12. Other features of the filter system 26 also may function to slow the velocity of the flow of the rainwater 12 as explained below.

In case the rainwater 12 overflows the filter system 26, such as in a very heavy downpour of rain, or when storage tanks become filled, some of the rainwater 12 may move out of the filter system 26 through the overflow pipe 57 and to an overflow pond 59. Other destinations for the overflow are possible. The overflow pipe 57 is located in a watertight connection to a sidewall 83 of the cube-shaped box 79 of the filter system 26. The sidewall 83 is substantially perpendicular to the sidewalls 80, 82. The overflow pipe 57 is connected to a hole 92 that is positioned substantially in the center of the sidewall 83. In the exemplary embodiment, the hole 92 is sized to fit the overflow pipe 57. In this example, the hole 92 has a diameter of about 8 ¾ inches.

Advantageously, the diversion of the rainwater 12 through the overflow pipe 57 also may slow the velocity of the flow of the rainwater 12 as it makes its way through the filter system 26.

The interior of the filter system 26 is divided into a filter side 87 and an overflow side 88 by a dividing wall 89. It extends from entry sidewall 80 to exit sidewall 82. The dividing wall 89 includes a first linear part 90 that is connected at one end to entry sidewall 80 and is connected at its other end to a second linear part 96 that is top-notched. In other words, the second part 96 of the dividing wall 89 is shorter than the first part 90 of the dividing wall 89. The second part 96 of the dividing wall 89 may be referred to as the short part 96. The second part 96 is connected at its end opposite to its connection to the first part 90 to the exit sidewall 82. The connections of the dividing wall 89 to entry sidewall 80, exit sidewall 82, and the inside bottom 94 of the filter box are watertight. The first part 90 and second part 96 may be integrally formed to form the dividing wall 89 or be otherwise constructed.

The dividing wall 89 is positioned to one side of the cube-shaped box's connection to the connection pipe 23. In the illustrated embodiment, the dividing wall 89 is to the left of the entry pipe 23 as viewed from the entry pipe 23. The first part 90 of the dividing wall 89 is substantially as tall or has a height substantially the same as the sidewalls of the cube-shaped box 79. The second part 96 of the dividing wall 89 is about half as tall as the first part 90 of the dividing wall 89. The second part 96 of the dividing wall 89 may be referred to herein as the short part 96 to distinguish it from the first part 90 of the dividing wall 89, which may be referred to herein as the tall part 90. The dividing wall 89 is positioned inside the cube-shaped box 79 so that the dividing wall 89 is substantially parallel to the longitudinal axes of the entry and exit pipes 23, 28. In other words, the dividing wall 89 runs substantially parallel to the flow of the rainwater 12 between the entry and exit pipes 23, 28 through the cube-shaped box 79.

In length, the tall part 90 of the dividing wall 89 runs about two-thirds of the length of the sidewall 83, of the cube-shaped box 79 or about sixteen inches in this embodiment. Other embodiments may vary. The end of the tall part 90 of the dividing wall 89 that is closest to the connective (entry) pipe 23 is fixed into the same sidewall 80 as the entry pipe 23. As noted, the dividing wall 89 is positioned to one side of the opening for the connective (entry) pipe 23 so the end of the tall part 90 of the dividing wall 89 is so positioned with respect to the opening for the connective (entry) pipe 23. In the exemplary embodiment, this end of the tall part 90 of the dividing wall 89 is connected to the sidewall 80 in a substantially vertical line disposed at about two-thirds (or about 16 inches) of the width of the sidewall 80.

The other end of the tall part 90 of the dividing wall 89 connects to one end of the short part 96 of the dividing wall 89. The other end of the short part 96 of the dividing wall 89 is fixed into the same sidewall 82 as the exit pipe 28. In the exemplary embodiment, this end of the short part 96 of the dividing wall 89 is connected to the sidewall 82 in a substantially vertical line disposed at about one third (or about 12 inches) of the width of the sidewall 82. The dividing wall 89, and so the short part 96 of the dividing wall 89, is positioned to the left (as viewed from the inside of the cube-shaped box 79 looking towards the delivery pipe 28) of the opening 81 for the exit pipe 28.

Another wall 96 within the cube-shaped box 79 is now described. The wall 96 is disposed in a curve of about a quarter of a circle between the filter side 87 of the dividing wall 89 and exit sidewall 82. As is explained below, the bottom of the curved wall 96 is lower in the cube-shaped box 79 than the short part 96 of dividing wall 89 is tall. Also, the top of curved wall 96 is lower in the cube-shaped box 79 than the top of the tall part 90 of the dividing wall 89. In sum, curved wall 96 serves as a skimmer to catch debris when the rainwater 12 overflows the filter side 87 of the cube-shaped box 79 into the overflow side 88.

In particular, near the place where tall part 90 of the dividing wall 89 connects to or becomes the short part 96 of the dividing wall 89, one end of the curved wall 96 connects to the dividing wall 89. The connection is a substantially vertical watertight connection. The curved wall 91 connects to the tall part 90 of the dividing wall 89 rather than the short part 96 of the dividing wall 89. The curved wall 91 makes such a connection because the bottom of the curved wall 91 is lower in the cube-shaped box 79 than the top of short part 96 of the dividing wall 89. On the other end, the top of the curved wall 91 does not reach as high as the first part 90 of the dividing wall 89 as is more particularly described below.

As noted, the other end of the curved wall 91 connects to exit sidewall 82. The connection is a substantially vertical watertight connection. The curved wall 91 connects to the exit sidewall 82 generally above the top most part of the exit hole 81. In other words, the bottom of the curved wall's connection to the exit wall 82 starts just above the top of the hole 81 and extends vertically upward but to a height greater than the second part 96 of the dividing wall 89 and less than the first part 90 of the dividing wall 89.

The curved wall 91 is shaped generally like the letter “C”. The body of the curved wall 91 curves into the direction of the flow of rainwater 12 through the filter side 87 of the cube-shaped box 79.

As noted, the curved wall 91 is connected in a watertight manner between the dividing wall 89 and the exit sidewall 82. But as also noted, the curved wall 91 does not reach the inside bottom 94 of the cube-shaped box 79. Rather, there is a space below the curved wall 91 and the inside bottom 94 of the cube-shaped box 79. The curved wall 91 also is shorter than the first part 90 of the dividing wall 89, but taller than the second part 96. Thus, the top of the curved wall 91 is about 4-inches from the top of the dividing wall 89. The bottom of the curved wall 91 is 10-inches above the bottom 94 of box. Other embodiments may vary.

The curved wall 91 is sized and disposed so that rainwater 12 may flow under the curved wall 91. So long as the rainwater 12 flowing underneath the curved wall 91 does not rise to the height of the second shorter part 96 of the dividing wall 89, the short part 96 helps to contain the rainwater 12 on the filter side 87 of the cube-shaped box 79 so the rainwater 12 may pass through to the delivery pipe 28. Once the rainwater 12 that flows under the curved wall 91 reaches the height of the second shorter part 96 of the dividing wall 89, the rainwater 12 flows over the second part of the dividing wall 89 into the overflow side 88 of the cube-shaped box 79. The rainwater 12 may continue from the overflow side 88 of the cube-shaped box 79 into an overflow pipe 57 as shown in FIG. 5.

In sum, the bottom of the curved wall 96 is lower than the top of the short part 96 of dividing wall 89. The rainwater 12 may flow under the bottom of the curbed wall 94 and is contained on the filter side 87 of the cube-shaped box 79 so long as the rainwater 12 does not reach the top of the short part 96 of the dividing wall 89. Again it is noted, the top part of the short part 96 of the dividing wall 89 is higher in the cube-shaped box 79 than the bottom of the curved wall 96. When the rainwater 12 reaches the top of the short part 96 of dividing wall 89, the curved wall 96 acts as a skimmer of debris with respect to the rainwater 12 passing under the curved wall and the over the top of the short wall 91 into the overflow side 88 of the cube-shaped box 79.

In the exemplary embodiment 10, the curved wall 91 is formed from part of a 16-inch HDPE pipe. In particular, the curved wall 91 is about one-fourth of a 16-inch HDEP pipe.

The dividing wall 89 may be made of any appropriate material. In the exemplary embodiment, the dividing wall 89 is made of HDPE. The dividing wall 89 has a thickness of about about ½ inch.

As noted, the dividing wall 89 divides the interior of the cube-shaped box 79 of the filter system into a filter side 87, which includes the openings for the entry pipe 23 and the exit pipe 28, and the overflow side 88, which includes the opening for the overflow pipe 57. Rainwater 12 flows through this filter side 87 of the cube-shaped box 79 from the entry pipe 23 to the exit pipe 28 unless the rainwater 12 rises to a level that is higher than the height of the second shorter part 96 of the dividing wall 89. If the rainwater 12 rises higher than the height of the short part 96 of the dividing wall 89, then at least some of the rainwater 12 flows into the overflow side 88 of the cube-shaped box 79. From the overflow side 88, the rainwater 12 may flow out of the cube-shaped box 79 through the overflow pipe 57 to the overflow pond 59. The overflow pipe 57 may dip in height from its connection to the filter system 26 to the overflow pond 59 so that the rainwater 12 may flow via gravity into the pond 59.

FIG. 5 also shows that there are three filters 84, 85, 86 disposed within the exemplary filter system 26. In particular, each filter 84, 85, 86 is disposed perpendicularly with respect to the longitudinal axes of the entry pipe 23 and the exit pipe 28. Thus, each filter 84, 85, 86 is positioned perpendicularly across the path of the rainwater 12 as it moves through the filter system 26. Advantageously, the rainwater 12 is filtered three times in this exemplary filter system 26 so as to remove debris that may clog the irrigation system 38. Other embodiments may use more or fewer filters, and/or filter(s) of different configurations. Yet other embodiments may not include a filter system.

Another advantage of the exemplary embodiment is that the filters 84, 85, 86 may slow the velocity of the rainwater 12. As noted, the filters 84, 85, 86 are positioned across the path of the rainwater 12 through the cube-shaped box 79. Even though the filters 84, 85, 86, pass the rainwater 12, each filter may slow the rainwater 12 by its filtering function. Of course, the more clogged a filter is with debris that it has filtered, the more the filter slows the rainwater 12 passing through it. The filters 84, 85, 86 are easily removed for cleaning as is explained below.

The filters 84, 85, 86 are positioned in the filter side 87 of the cube-shaped box 79 between the dividing wall 89 (that divides the cube-shaped box 79 into the filter side 87 and the overflow side 88) and sidewall 95. More particularly, the filters 84, 85, 86 are positioned generally perpendicularly between the first part 90 of the dividing wall 89 and the sidewall 95 that is opposite to sidewall 83, which is connected to the overflow pipe 57.

The exemplary embodiment 10 allows for the separate removal and replacement of each of the filters 84, 85, 86. Two routed grooves per filter facilitate this removal and replacement. The grooves are not shown in FIG. 5 because the filters 84, 85, 86 are shown in place in the filter system 26. A groove also may be referred to herein as a “slide guide”.

One of the grooves for each filter is in the first part 90 of the dividing wall 89. The other groove for each filter is in the sidewall 95 of the cube-shaped box. As noted, sidewall 95 is opposite sidewall 83, and perpendicular to sidewalls 80, 82. Each groove is as long as the wall in which it is set. Each groove is just slightly wider than the filter, which the groove receives. The depth of each groove is about ¼-inch. Each groove runs the length of the element of the filter system 26 in which the groove is made. In particular, each groove runs the length of the first part 90 of the dividing wall 89 or the sidewall 95. Each groove is substantially rectangular in shape. To place a filter 84, 85 or 86 in the filter system 26, a user may position each side of the filter so the sides of the filter slide into their respective grooves. The user then pushes the filter down until the bottom of the filter rests against the inside bottom of the cube-shaped box 79. The filters 84, 85, 96 are ultimately retained against uplift and displacement from their intended positions across water stream by the dividing wall 89 and the bottom 69 of the cube-shaped box 79, the slide guides, and the top cover of the cube-shaped box 79, which is omitted from FIG. 5 for clarity of otherwise concealed interior components.

Another embodiment may provide a groove in the inside bottom of the cube-shaped box 79 for a filter so that the filter does not rest against the inside bottom, but is sunk a bit into the inside bottom by being fit into the groove on the inside bottom.

To remove a filter 84, 85, 86, the user may grasp a filter 84, 85, 86 and pull it straight up until the entire filter is released from the grooves in which it was positioned.

As an alternative to the routed (recessed) slide guides for the filters 84, 85, 86, another embodiment may include protruding tabs on each side of each filter 84, 85, 86 on each side of the cube-shaped box 79. These tabs may be HDPE flat bar or strips of HDPE plate attached to the inside walls or sides of the cube-shaped box 79.

The filters 84, 85, 86 are spaced apart from each other. To explain this spacing, please consider the length of the cube-shaped box 79 to be the direction parallel to the longitudinal axes of the pipes 23, 28. Thus, the filters 84, 85, 86 are spaced apart along the length of the cube-shaped box 79 and between the dividing wall 89 and the sidewall 95 of the cube-shaped box 79 of the filter system 26. The filters 84, 85, 86 in the exemplary embodiment are spaced apart by about three to five inches. The intent of having the multiple filters is to provide and allow for progressively sized bar racks, grates, screens, filter mesh or other suitable forms of rigid, flexible or pliable media to be used for providing desired waste removal capabilities as intended for differing applications.

By way of further explanation, the filters 84, 85, 86 are disposed generally parallel to each other and to the sidewalls 80, 82 of the cube-shaped box 79, and disposed perpendicularly with respect to the top (not shown) and bottom 94 and sidewalls 83, 95 of the filter system's cube-shaped box 79.

Further, each filter 84, 85, 86 also is disposed so it completely spans the interior height of the filter system 26. As noted previously, each filter 84, 85, 86 also spans the space on the filter side 87 between wall 89 and sidewall 95. Thus, as will become apparent from the discussion of the openings in the filters, the only way for the rainwater 12 to flow through the filter side 87 is to flow through the filters 84, 85, 86. Other embodiments may not have filters as tall as the filters 84, 85, 86.

The filters 84, 85, 86 may have “handles” that are formed by an overflow slot provide near the top of each filter 84, 85, 86, directly above the filter portion of each filter 84, 85, 86. This overflow slot is covered on its receiving side by a curvilinear skimmer to remove floatables from the stream of rainwater 12. Advantageously should any filter become filled, blocked, or plugged by the debris as removed by the filter, then that filter still functions by the rainwater 12 rising to flow through the overflow slot of the filter. The overflow slot with skimmer forms a weir as will be understood by those skilled in the art. The overflow slot of a filter may also serve as its handle. Thus, a progressive method of continued removal capability by bypassed rainwater 12 flow is performed by filters 84, 85, 86, so that they may be easily individually removed from the cube-shaped box 79 for easy cleaning and replacement. In this embodiment of the filter system 26, the filters 84, 85, 86 may be removed from the top of the cube-shaped box 79 as noted previously. Other embodiments may vary.

The filters 84, 85, 86 may be made of any appropriate material that withstands the flow of the rainwater 12 through the filter system 26 and that allows the filters 84, 85, 86 to carry out their eponymous function. In this embodiment, the filters 84, 85, 86 are made of aluminum plate, but other materials may be used in whole or in part.

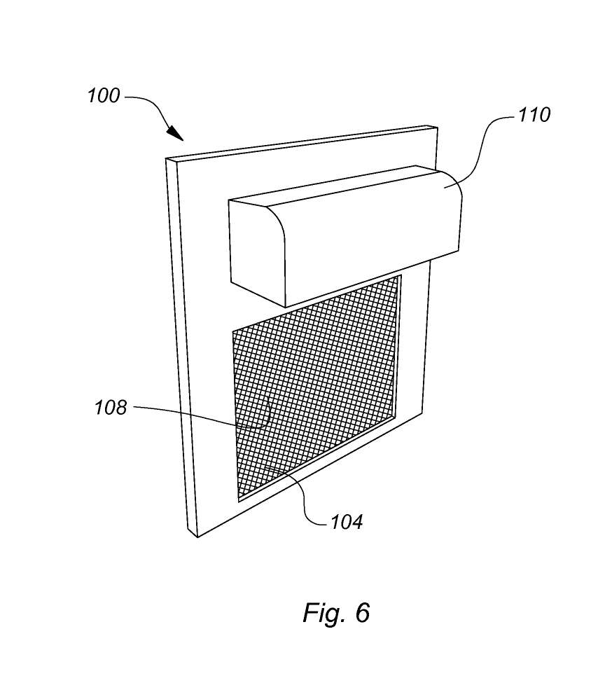

FIG. 6 shows a filter 100 that may be used with the exemplary filter system 26 of the invention. In other words, filter 100 compares to filters 84, 85, 86. The filter 100 is generally rectangular in shape being taller than it is wide. The filter 100 for use in the filter system 26 is about 24 inches tall, 16 inches wide, and about ¾-inch thick.

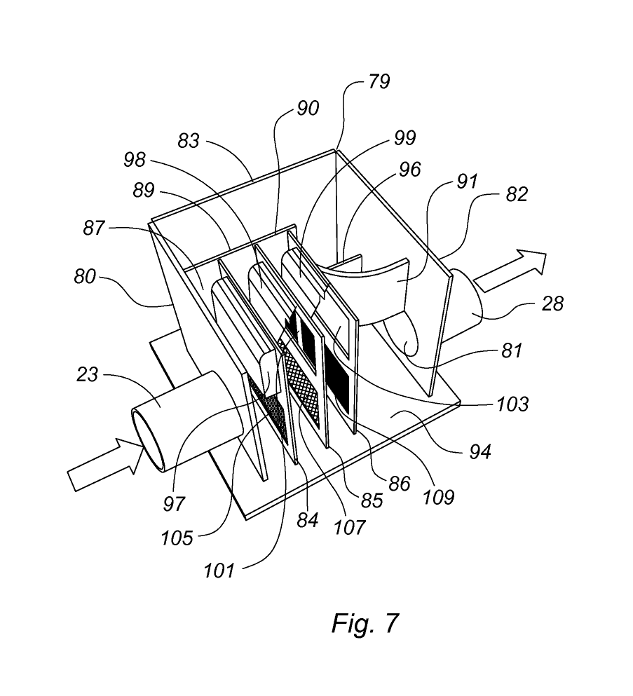

The filter 100 has two openings. Opening 104 is the lower and bigger of the two openings. The top opening is not visible in FIG. 6 because the skimmer 110 covers the top opening. See FIG. 7 for a cutaway view of two skimmers on filters. Opening 104 is about twice as tall as the top opening. In particular, in the exemplary embodiment 10, the size of the lower opening 104 is about 10-⅞-inches×11-inches. The size of the top opening is about 10-⅞ inches×6-inch.

Also, the lower opening 104 of the filter 100 is covered by a screen 108 to remove debris from the rainwater 12 that passes through the screen 108. The screen 108 may be made of any appropriate material that may withstand the flow of the rainwater 12 and that may carry out the function of filtering debris from the rainwater 12.

Reference is now made again to the filter system 26 shown in FIG. 5. In the exemplary embodiment 10, as noted, three filters 84, 85, 86 are used in the filter system 26. Each filter 84, 85, 86 has openings similar to the openings 104, in the filter 100 shown in FIG. 6. Each filter 84, 85, 86 in the filter system 26 shown in FIG. 5 includes a screen over its larger opening. Moving from the entry pipe 23 to the exit pipe 28, the screens in the respective larger openings of the filters 84, 85, 86 filter succeeding smaller debris from the rainwater 12. In other words, the screen of the first filter 84 in the path of rainfall flow blocks debris of a particular size. The screen of the second filter 85 blocks debris that is smaller than the particular size blocked by the first filter 84. The screen of the third filter 86 blocks debris that is smaller than the debris blocked by the second filter 85. The filters 84, 85, 86 may accomplish this ever smaller debris blocking by having respective filters of different, succeeding finer gauge or mesh size.

In the alternative, filter 84 may include a one-dimensional grate that includes spaced bars extending across the lower opening in only one direction. This “bar grate” filter may be useful for removal of the larger debris from the water stream.

Additionally, filters 84, 85, 86 may alternately include other than the vertical filter materials shown in the exemplary embodiments of FIGS. 5 and 7. The alternatives may include one or more of the following: nets, bags, or other synthetic catchments. These may also be designed or arranged to allow nesting, or passage of one inside of the other. Moreover, the alternatives may be used in a cooperative fashion with the vertical filter elements mentioned herein.

Also in the exemplary filter system 26 in FIG. 5, the three filters 84, 85, 86 include respective top openings like the top opening in filter 100 in FIG. 6. The top openings in the filters 84, 85, 86 are included to facilitate the movement of the rainwater 12 when it rises to the height of the top openings in the filters 84, 85, 86. To reach the top opening in a filter, the rainwater 12 may have a heavy flow or may be blocked substantially from flowing through the covered opening of the filter such as by clogging debris. To accommodate this issue, the top opening allows the rainwater 12 to pass without filtering. Otherwise, for example, when the heavy flow of rainwater 12 encounters a filter without a top opening, the filter without the top opening may lead to an undesirable back up of the rainwater 12.

FIG. 6 shows that the exemplary filter 100 includes a skimmer 110 over the top opening (not seen in FIG. 6 because the skimmer 110 covers the opening). The skimmer 110 is positioned on the side of the filter 100 through which the rainwater 12 exits the filter 100. The skimmer 110 in this embodiment is an arc-shaped element that covers the top opening in the filter 100 in a manner similar to the way an awning covers a window. The arc of the skimmer 110 is about that of a quarter of a circle in this embodiment. Other embodiments may vary. The skimmer 110 also may be referred to as a “hood”.

Skimmer 110 has a width that may be substantially the same as or slightly wider than the top opening in the filter 100. One long side of the skimmer 110 is attached substantially perpendicularly to the filter 100 above and along the top opening. In place, the skimmer 110 arcs away from its connection to the filter 100 to run substantially parallel to and spaced apart from the top opening in the filter 010. The shape of the skimmer 110 may be compared to an inverted letter “J”.

The skimmer 110 as its name implies skims the rainwater 12 of debris passing through the top opening of the filter 100. The skimming of rainwater 12 by skimmer 110 may lead to more of the rainwater 12 having floatable debris removed and non-floatable debris filtered rather than by excess flows being bypassed into the next filter. In other words, more rainwater 12 may be treated by having the skimmer 110 in place than not.

The primary function of the skimmer 110 is debris collection. As the water level builds up in the filter system 26, the skimmer 110 may skim anything floating on top of the rainwater 12 and may prevent the debris from flowing through the opening the skimmer 110 covers. .

Reference now is made to FIG. 7 to provide information on the skimmers 97, 98, 99 used on filters 84, 85, 86 in the exemplary filter system 26. Each of the skimmers 97, 98, 99 is disclosed as covering the respective top openings in the filters 84, 85, 86. With respect to filter 84, skimmer 97 is shown as completely covering the top opening so that the top opening is not shown in FIG. 7. With respect to filters 85, 86, however, their respective skimmers 98, 99 are shown in cutaway in part so that the respective top openings 101, 103 of filters 85, 86 are visible at least in part.

Reference again is made to FIG. 7 to summarize the rainwater 12 flow through the exemplary filter system 26. FIG. 7 lacks sidewall 95 so that the interior of the filter system 26 may be seen. The rainwater 12 enters the cube-shaped box 79 of the filter system 26 from the connective pipe 23. The rainwater 12 flows through the screened bottom opening of the first filter 84. The bottom opening is covered by a screen 105. The screen 105 is sized to filter debris of a larger size than the subsequent screens 107, 109 respectively in filters 85, 86.

The screen 105 covering the bottom opening of the filter 84 continues to filter rainwater 12 at least until the screen 105 becomes substantially clogged by trapped debris or for other reasons. As noted previously, each of the filters including filter 84 has a top opening that is unscreened. The top opening in filter 84 is not visible because the filter's skimmer 97 is shown in full in FIG. 7. The filter's skimmer 97 covers the top opening in filter 84.

If the rainwater 12 increases in depth in front of filter 84 such that the surface of the rainwater 12 is above the bottom of the top opening of the filter 84, whether as a result of the screen 105 on the bottom opening being substantially clogged by trapped debris or for other reasons, then and for as long as the surface of the rainwater 12 is at or above the bottom of the top opening of the filter 84, the rainwater 12 is skimmed of floatable debris by skimmer 97. The skimmed rainwater 12 then flows through the top opening of filter 84.

After the rainwater 12 passes the first filter 84, the rainwater 12 continues to pass through the filter system 26 and next encounters the second filter 85. As with the first filter 84, the rainwater 12 passes through the bottom opening of the second filter 85. The bottom opening is covered by a screen 107. The screen 107 is sized to filter debris of a smaller than the size of the debris filtered by filter 84 and larger than the size of the debris filtered by the subsequent filter 86.

The screen 107 covering the bottom opening of the filter 85 continues to filter rainwater 12 at least until the screen 107 becomes substantially clogged by trapped debris or for other reasons. The top opening 101 in filter 85 is partially visible because the filter's skimmer 98 is shown in cutaway in FIG. 7. In practice, the filter's skimmer 98 covers the top opening 101 in filter 85.

If the rainwater 12 increases in depth in front of filter 85 such that the surface of the rainwater 12 is above the bottom of the top opening 101 of the filter 85, then and for as long as the surface of the rainwater 12 is at or above the bottom of the top opening 101 of the filter 85, the rainwater 12 is skimmed of floatable debris by skimmer 98. The skimmed rainwater 12 then flows through the top opening 10 of filter 85.

After the rainwater 12 passes the second filter 85, the rainwater 12 continues to pass through the filter system 26 and next encounters the third filter 86. As with the first and second filters 84, 85, the rainwater 12 passes through the bottom opening of the third filter 86. The bottom opening is covered by a screen 109. The screen 109 is sized to filter debris of a smaller than the size of the debris filtered by the second filter 85. In this embodiment, filter 86 is the filter that filters debris of the smallest size.

The screen 109 covering the bottom opening of the filter 86 continues to filter rainwater 12 at least until the screen 109 becomes substantially clogged by trapped debris or for other reasons. The top opening 103 in filter 86 is partially visible because the filter's skimmer 99 is shown in cutaway in FIG. 7. In practice, the filter's skimmer 99 covers the top opening 103 in filter 86.

If the rainwater 12 increases in depth in front of filter 86 such that the surface of the rainwater 12 is above the bottom of the top opening 103 of the filter 86, then and for as long as the surface of the rainwater 12 is at or above the bottom of the top opening 103 of the filter 86, the rainwater 12 is skimmed of floatable debris by skimmer 99. The skimmed rainwater 12 then flows through the top opening 103 of filter 86.

After the rainwater 12 passes the third filter 86, the filtered rainwater 12 may pass out of the filter system 26 through hole 81 with its connected pipe 28 and through connected piping into the tanks If the rainwater 12 flow is heavy, or for other reasons, the rainwater 12 may rise in the filter system 26 even after it passes through the third filter 86. If the rainwater 12 rises to the height of the short part 96 of the dividing wall 89, then the filtered rainwater 12 is further skimmed of floatable debris by curved wall 91. The skimmed rainwater 12 will flow beneath the curved wall 91 and over top of the short part 96 of the dividing wall 89 and into the overflow area 88. From the overflow area 88, the overflow rainwater 12 may pass out through the overflow pipe 57, if the overflow rainwater 12 rises to the height of the opening 92 of the overflow pipe 57.

An advantage of the exemplary filter system 26 is its filtering of the rainwater 12 in many ways. The rainwater 12 passes through succeedingly finer screens 105, 107, 109 in the filters 84, 85, 86 in the cube-shaped box 79. In addition, the rainwater 12 may be skimmed by one or more of the skimmers 97, 98, 99 that cover the top openings in the filters 84, 85, 86. The last filtering in this exemplary filter system 26 is the skimming carried out by the curved wall 96 inside the cube-shaped box 79 when the rainwater 12 passes underneath the curved wall and over the top of the short part of the dividing wall 89.

Advantageously, should the storage tanks fill to capacity by excess rainfall received or reduced irrigation, the above mentioned outflows of filter system 26 allow flows to be safely directed away from the storage tanks 30a, 30b and disturbed soil and backfill of excavation 31 and the filter system 26 and all related piping and appurtenances, which is of considerable protective benefit, “water logging” of tanks usually forces overflows through vents and leads to soil erosion by uncontrollable flows. This is prevented by the preferred embodiment.

FIG. 8 is a top view of an exemplary embodiment 112 of the invention as used to harvest, store, and use rainwater 12 that runs off a structure, which is represented by building foot print 114. The structure 114 includes a surrounding gutter system 116 with downspouts 118a-r.

Embodiment 112 uses two pairs of storage tanks 120a-b, 122a-b. Each pair 120a-b, 122a-b is disposed on opposite corners of the generally rectangular footprint 114 of the structure 114. Thus, each pair of storage tanks 120a-b, 122a-b has its own respective collection pipe 124, 126 connected to respectively designated downspouts on the structure 114, and respective connection pipe 128, 130 that delivers the harvested rainwater 12 to their respective filter systems 132, 134.

In the embodiment 112 of FIG. 8, the respective signal connection 136, 138 from the float switch (not shown) in at least one of the two storage tanks in each pair 120a-b, 122a-b is made on the side of the respective filter system 132, 134. The signal connections 136, 138 signal the controller 140 when the respective pair of storage tanks 120a-b, 122a-b run dry. The signal connections 136, 138 may be made in any appropriate fashion. In an exemplary embodiment, the float switch completes a circuit when the storage tank is empty. Completion of the circuit sends a signal through the wiring via the input side of the storage tank or the output side of the storage tank, and ultimately, to the controller.

As with the exemplary embodiment 10, the storage tanks 120a-b, 122a-b contain about the same amount of rainwater 12 due to being filled at the same rate as each other and being emptied at the same rate. Another embodiment may include a float switch in each storage tank and monitor the empty status of each such tank.

If the float switches indicate that the storage tanks 120a-b, 122a-b are empty, the controller 140 opens the valve 142 between the irrigation system 143 and the water supply source 144 when irrigation is desired so that the water for the irrigation may be obtained from the water supply source 144 rather than the exemplary embodiment 112.

If there is water in either of the pair of storage tanks 120a-b, 122a-b, however, the exemplary embodiment 112 delivers the water from the storage tanks with the water to the irrigation system 143. The controller 140 may open valves (not shown) on the storage tanks 120a-b, 122a-b. The water exits the storage tanks 120a-b, 122a-b into the respective irrigation delivery piping system 146, 148. These piping systems 146, 148 come together (not shown in FIG. 8 because they run together underground) into a single pipe 150 to pass the rainwater 12 through a filter 152 and a hydro tank 154. After the rainwater 12 passes through the filter 152, the rainwater 12 is delivered to the irrigation system 143.

Although the exemplary embodiment is by two pairs of storage tanks, there may alternately be additional pairs added to the system, and additional tanks added to each pair of tanks Advantageously, this addition of tanks whether as pairs or to pairs is unlimited and variable so that the embodiments of the invention may accommodate water demands of varying sizes.

A controller is mentioned above in connection with the exemplary embodiments. A controller may be embodied in any appropriate form to carry out its function in connection with the invention. For example, an electronic or electro-mechanical controller may be used such as a programmable controller. Moreover, the controller may be made to work with irrigation controllers such as those available from Rain Bird Corporation. For information, see www.rainbird.com.

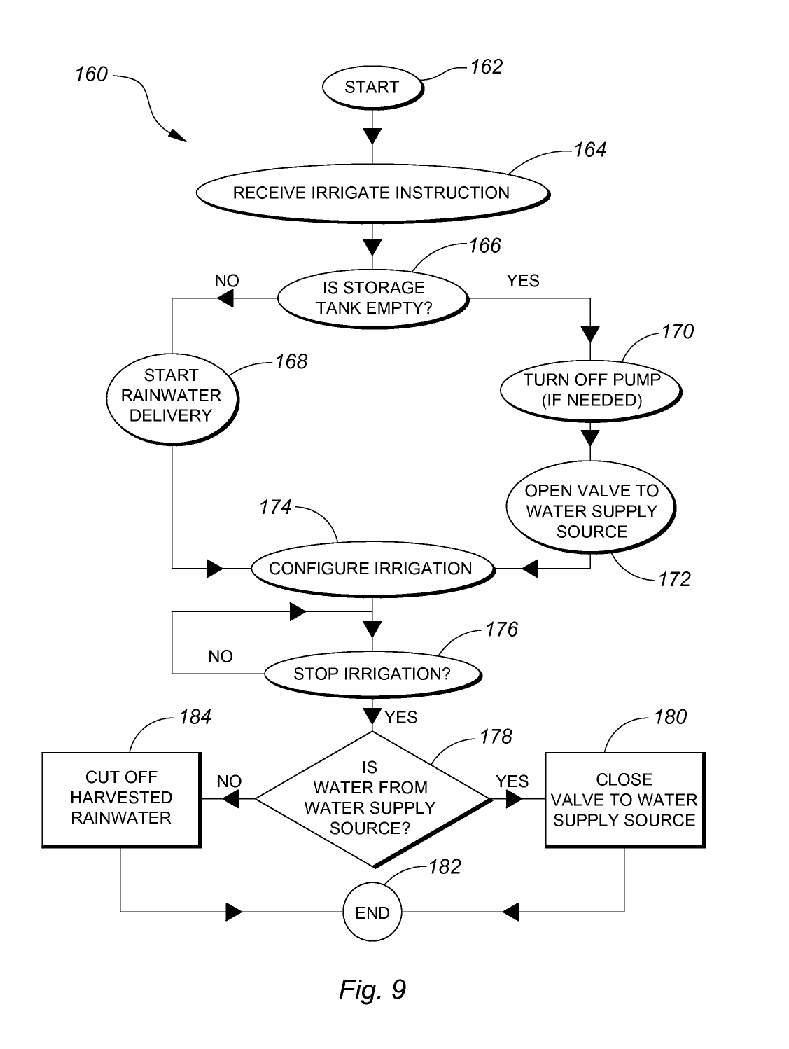

FIG. 9 is a flow diagram 160 illustrating logic a controller may follow in connection with the exemplary embodiments of the invention. After the start action 162, the controller may monitor for an irrigation instruction in action 164. An irrigation instruction also may be referred to as a turn-on irrigation instruction. For example, a master gardener may use a wireless device to send an “irrigate” instruction to the controller. When a valve 40a-d is turned on, the harvested filtered stored rainwater 12 is delivered in the exemplary embodiment 10 to flexible irrigation tubing that lies on top of mulch beds of the irrigation area and conveys the filtered stored rainwater 12 to the step-down micro-jet spray heads of the sprinklers 41a-d.

In response, in action 166, the controller may check whether harvested stored rainwater 12 is available from the one or more storage tanks in use with the embodiment of the invention. As noted previously, in the exemplary embodiment, a float switch in a storage tank sends an indication to the controller if it tank is empty of rainwater 12.

If rainwater 12 is available, then in action 168, the controller may take what action is necessary to begin or to cause to begin delivery of the rainwater 12 to the irrigation destination. In some embodiments, the action may be to open the valve(s) on the outlet(s) of the storage tank(s). The controller may start or cause the pump of the embodiment to start and to begin moving the rainwater 12 to the irrigation destination. Some embodiments do not require the controller to start the pump.

In action 174, the controller may configure irrigation, (or cause configuration of the irrigation) if the particular embodiment of the invention allows for such an action. For example, a master gardener may instruct the controller to turn on some, but not all, of the sprinklers in the irrigation system. The controller may respond by sending a signal to the appropriate sprinklers to turn on, etc.

In the exemplary embodiment, the irrigation system 38 includes a loop irrigation trunk line 36 of about 1,000 feet in a generally rectangular shape. The loop irrigation trunk line 36 also may be referred to herein as the main line 36. The loop irrigation trunk line 36 connects to ten valves 40a-d (only four are shown in FIG. 1). Each valve 40a-d may be positioned to supply water to respective sprinklers 41a-d. Alternatively, each valve 40a-d may supply more than one sprinkler The controller may configure the ten valves 40a-d so all of the boxes 40a-d deliver the harvested filtered stored rainwater 12, or some do and do not.

Referring back to action 166, if the controller finds that the one or more storage tanks are empty, then in action 170, the controller may cause the pump to turn off, if such action is needed. The controller may cause the valve(s) on the outlet(s) of the storage tank(s) to close.

Further, in action 172, the controller opens the valve to the water source so that the irrigation system is provided with water from that source. The controller may carry out action 174 in configuring the irrigation prior to opening the valve in action 172.

Thereafter, the controller monitors for an instruction to stop irrigation in action 176. If a stop irrigation instruction is received, then the controller may need to check in action 178 whether the irrigation water is provided by the water supply source or by the storage tank(s) of the exemplary embodiment. If the water is from the water supply source, then in action 180 the controller may close the valve to the water supply source and the flow logic ends in action 182.

If the water is from the storage tank(s), then in action 184 the controller may cut off the harvested rainwater 12 from being delivered to the irrigation system. The cut off may be carried at one or more points in the exemplary embodiment. For example, the controller may close the valve(s) on the outlets of the storage tank(s), may activate cutoff valve(s) such as shown as 72a-b in the embodiment of FIG. 3, and/or may activate the cutoff valve 54 that follows in series after the hydro tank 52 in the embodiment of FIG. 3. The flow logic ends in action 182.

### CONCLUSION

From the foregoing description of the exemplary embodiments of the invention and operation thereof, other embodiments will suggest themselves to those skilled in the art. Therefore, the scope of the invention is to be limited only by the claims below and equivalents thereof.

We claim:

1. In a system for harvesting rainwater from a roof of a structure located above ground, the system including one or more gutters positioned with respect to the roof to receive the rainwater, and the one or more gutters further positioned to deliver by gravity the rainwater to one or more downspouts, each downspout having a top end connected to the one or more gutters to receive the rainwater from the one or more gutters,
a system for filtering the rainwater, storing it, and using it to irrigate, comprising:
a collection pipe located below the one or more downspouts;
each of the one or more downspouts having a bottom end opposite its top end with the bottom end of the downspout connected to the collection pipe so the collection pipe receives the rainwater via gravity from the one or more downspouts;
the collection pipe having a downward slope at least at one end towards a connective pipe to which the collection pipe makes a watertight connection so the collection pipe delivers the rainwater via gravity to the connective pipe;
the connective pipe having a downward slope from the collection pipe to a filter system to which the connective pipe makes a watertight connection so the connective pipe delivers the rainwater via gravity to the filter system;
the filter system being watertight and operational to filter debris from the rainwater;
the filter system having a watertight connection to piping, which delivers via watertight connection the filtered rainwater to a top opening in a storage tank;
the storage tank being watertight and having an outlet near or at its bottom;
the irrigation delivery piping system having a watertight connection at its second end to at least an irrigation system; and
the pump being operable with the irrigation delivery piping system when the pump is activated to pump the filtered rainwater through the irrigation delivery piping system from the outlet of the storage tank to the irrigation system.

2. The system of claim 1, wherein at least part of the connective pipe, at least part of the filter system, the whole storage tank, and at least part of the irrigation delivery piping system are buried underground.

3. The system of claim 2, wherein the underground storage tank comprises at least a vent pipe with a watertight connection at one end to an opening in the top of the underground storage tank providing access to interior of the underground storage tank; and
the other end of the vent pipe being above ground and having an opening to vent air from the interior of the underground storage tank to above ground.

4. The system of claim 1, wherein the storage tank comprises a tank at least previously intended for storing petroleum products.

5. The system of claim 1, further comprising:
a cut-off valve connected to the irrigation delivery piping system between the outlet of the storage tank and the pump, and
the cut-off valve being selectively manually operable to block flow of the filtered rainwater in the irrigation delivery piping system before the filtered rainwater reaches the pump.

6. The system of claim 1, further comprising:
a hydropneumatic water tank connected to the irrigation delivery piping system and operable to deliver the filtered rainwater in a preset pressure range to the irrigation system.

7. The system of claim 1, further comprising:
a centrifugal filter connected to the irrigation delivery piping system to filter particulates from the filtered rainwater prior to delivery of the filtered rainwater to the irrigation system.

8. The system of claim 1, further comprising:
a piping connection connected at one end to the irrigation system and connected at its other end to a water supply source;
a water supply source valve connected between the piping connection and the water supply source,
the water supply source valve being selectively operable to close the piping connection to be watertight so as to block water from the water supply source, and
the water supply source valve being selectively operable to open the piping connection to allow the water from the water supply source to flow through the piping connection to the irrigation system; and
a controller being communicatively connected to the water supply source valve to selectively cause the water supply source valve to open, or to cause the water supply source valve to close.

9. The system of claim 8, further comprising:
a back flow preventer for preventing the filtered rainwater from entering the water supply source.

10. The system of claim 8, further comprising:
a float switch disposed inside the storage tank and communicatively connected to the controller,
the float switch operable to provide an indication to the controller when the storage tank is empty of the filtered rainwater.

11. The system of claim 10, wherein the controller responds to the indication from the float switch that the storage tank is empty of the filtered rainwater by causing the water supply source valve to open to allow the water from the water supply source to flow through the piping connection to the irrigation system.

12. The system of claim 11, further comprising a check valve between the irrigation delivery piping system and the irrigation system for blocking the water from the water supply source.

13. A system for filtering harvested rainwater, storing it, and delivering it to an irrigation system, comprising:
a ground excavation having a substantially flat bottom, the excavation being big enough to contain a storage tank;
bedding material disposed on top of the bottom of the excavation;
the storage tank being positioned in the excavation on the bedding material;
backfill substantially filling the excavation with the bedding material to bury the storage tank;
the storage tank having at least a vent pipe that reaches above ground;
a filter system for filtering debris from harvested rainwater delivered to the filter system,
the filter system being connected to the storage tank to deliver the filtered harvested rainwater to the storage tank;
the storage tank being connected to a delivery system for delivering the filtered harvested rainwater to the irrigation system; and
the delivery system being responsive to a signal to cause the storage tank to release the filtered harvested rainwater and to cause delivery of the filtered harvested rainwater to the irrigation system.

14. A system for using stored rainwater for irrigation in an irrigation system with the irrigation system being connected to a water source for water to use for the irrigation if there is no stored rainwater, comprising:
a valve positioned between the water source and the irrigation system,
the valve being closed to block the water from the water source from the irrigation system, and
the valve being responsive to an open signal from a controller to open to allow the use of the water from the water source for the irrigation by the irrigation system;
a storage system for storing the rainwater;
the storage system including an empty indicator that sends an empty indication to the controller if the storage system is substantially empty of the stored rainwater;
the controller responsive to a turn-on irrigation instruction to check for the empty indication, and
the controller operative to cause a distribution system to transport the stored rainwater from the storage system for delivery to the irrigation system if the controller fails to find the empty indication, and
the controller operative to send the open signal to the valve if the controller finds the empty indication.

15. The system of claim 14, wherein the distribution system includes a filter to filter debris from the stored rainwater prior to the delivery of the rainwater to irrigation system.

16. The system of claim 14, wherein the distribution system comprises a check valve between the irrigation system and the distribution system to prevent the water from the water supply from entering the distribution system.

17. The system of claim 14, wherein the storage system comprises an underground storage tank formerly used for storing gasoline and having an air vent to the surface.

18. The system of claim 14, wherein the empty indicator comprises a float switch.

19. The system of claim 14, wherein the distribution system comprises a pump and a hydropneumatic water tank.
